(19) United States
(12) Patent Application Publication
(10) Pub. No.: US 2017/0068946 A1
(43) Pub. Date: Mar. 9, 2017

(54) USER EQUIPMENT, SERVICE PROVIDING DEVICE, POS TERMINAL, PAYMENT SYSTEM INCLUDING THE SAME, CONTROL METHOD THEREOF, AND NON-TRANSITORY COMPUTER-READABLE STORAGE MEDIUM STORING COMPUTER PROGRAM RECORDED THEREON

(71) Applicant: SK Planet Co., Ltd., Gyeonggi-do (KR)

(72) Inventor: Sebyung KWAK, Seoul (KR)

(73) Assignee: SK Planet Co., Ltd., Gyeonggi-do (KR)

(21) Appl. No.: 15/254,589

(22) Filed: Sep. 1, 2016

(30) Foreign Application Priority Data
Sep. 8, 2015 (KR) 10-2015-0126965
Sep. 8, 2015 (KR) 10-2015-0126966

(51) Int. Cl. G06Q 20/32; G06F 21/84; G06K 9/00; G06Q 20/20; H04N 7/18; G06Q 20/40; G06F 21/62

(52) U.S. Cl. CPC G06Q 20/3227; G06Q 20/4012; G06Q 20/40145; G06F 21/84; G06F 21/6245; G06Q 20/206; G06Q 20/3226; H04N 7/183; G06K 9/00268; G06K 9/00288; G06K 9/00255; H04W 88/02

(57) ABSTRACT

Provided are user equipment, a service providing device, a POS terminal, a payment system including the same, a control method thereof, and a non-transitory computer-readable storage medium storing a computer program recorded thereon. That is, according to the present invention, it is possible to obtain image information through a front camera equipped on a front surface of user equipment when a predetermined important screen such as reception of a PIN number corresponding to a payment card is displayed in the user equipment, recognize one or more objects through an object recognizing function in the obtained image information, and suppress exposure of information on the important screen in accordance with a user input by a predetermined function when a user other than a pre-registered user is included in the one or more recognized objects.

### CROSS-REFERENCE TO RELATED APPLICATION

This application claims the benefit of Korean Application Nos. 10-2015-0126965 and 10-2015-0126966 filed on Sep. 8, 2015 with the Korean Intellectual Property Office, the disclosure of which is incorporated herein by reference.

### BACKGROUND OF THE INVENTION

1. Field of the Invention

The present invention relates to user equipment, a service providing device, a POS terminal, a payment system including the same, a control method thereof, and a non-transitory computer-readable storage medium storing a computer program recorded thereon. More particularly, the present invention relates to user equipment, a service providing device, a POS terminal, a payment system including the same, a control method thereof, and a non-transitory computer-readable storage medium storing a computer program recorded thereon which obtain image information through a front camera equipped on a front surface of user equipment when a predetermined important screen such as reception of a PIN number corresponding to a payment card is displayed in the user equipment, recognize one or more objects through an object recognizing function in the obtained image information, and suppress exposure of information on the important screen in accordance with a user input by a predetermined function when a user other than a pre-registered user is included in the one or more recognized objects.

2. Description of the Related Art

In accordance with generalization of mobile payment, a situation that inputs information on a mobile screen in a payment location is frequently generated.

In this situation, a risk of exposing a PIN number to a third party may be increased.

In order to cope with the risk, a film which makes a screen invisible from the side is used or a method of masking a key image is used. However, according to the methods, an additional means is required or a user also has a difficulty in inputting information.

Further, a beacon or a wireless hub equipped in a store transmits a wireless signal such as a BLE beacon signal to advertise the store or a service and user equipment which is close to the beacon or the wireless hub receives the wireless signal transmitted from the beacon or the wireless hub and displays information included in the received wireless signal.

However, the user equipment simply receives and displays information which is provided from the store so that it is difficult to perform an additional service function based on the information provided from the store.

Further, authentication is performed only using information provided from an operator of the user equipment so that problems such as information stealing or illegal use may occur.

### RELATED ART DOCUMENT

### Patent Document

Korean Unexamined Patent Application Publication No. 10-2004-0089422 (entitled Personal information input system for suppressing leakage of information from peeping operation)

### SUMMARY OF THE INVENTION

An object of the present invention is to provide user equipment, a service providing device, a POS terminal, a payment system including the same, a control method thereof, and a non-transitory computer-readable storage medium storing a computer program recorded thereon which monitor a rear side of a user which cannot be watched by the user through a front camera equipped in user equipment to suppress a peeping situation by a third party when privacy information, important information or a password is input on a payment screen and notify the user when a face of the third party is detected.

Another object of the present invention is to provide user equipment, a service providing device, a POS terminal, a payment system including the same, a control method thereof, and a non-transitory computer-readable storage medium storing a computer program recorded thereon which check the user through the front camera on the payment screen to simultaneously basically discern a user and check a third party using feature points of a face of the user.

An object of the present invention is to provide user equipment, a service providing device, a POS terminal, a payment system including the same, a control method thereof, and a non-transitory computer-readable storage medium storing a computer program recorded thereon which checks and discerns whether a user joins as a member by analyzing a face of the user through a camera configured on a POS terminal and store image information obtained by the camera when the user makes a payment as a record.

Still another object of the present invention is to provide user equipment, a service providing device, a POS terminal, a payment system including the same, a control method thereof, and a non-transitory computer-readable storage medium storing a computer program recorded thereon which detect information on a user of user equipment in advance when a check-in procedure is performed through a beacon at the time of performing simple payment to provide the information to a POS terminal and distinguish the user of the user equipment in the POS terminal.

According to an aspect of the present invention, user equipment includes: a user equipment display unit which displays a predetermined screen to receive information in accordance with user input; a front camera which obtains image information when the predetermined screen is displayed on the user equipment display unit; and a user equipment control unit which performs an object recognizing function on the obtained image information to recognize one or more objects included in the image information and checks whether information is leaked from the predetermined screen during an information receiving process, based on a feature of one or more recognized objects.

In an embodiment of the present invention, the predetermined screen may include any one of a PIN number receiving screen for receiving a PIN number corresponding to a selected payment card after selecting a payment card, a payment card number receiving screen for receiving a payment card information, a security card number receiving screen for receiving a security card number, and a personal information receiving screen for receiving personal information.

In an embodiment of the present invention, the front camera may obtain surrounding and rear image information of the user in a state when the user of the user equipment watches the front camera.

In an embodiment of the present invention, when the recognized object is a single object, the user equipment control unit may calculate a similarity between feature information of the recognized object and feature information of a predetermined reference object and check whether the calculated similarity is equal to or higher than the predetermined reference value.

In an embodiment of the present invention, when the calculated similarity is lower than the predetermined reference value, the user equipment control unit may suppress information leakage in accordance with the user input in a predetermined screen displayed on the user equipment display unit through a predetermined function.

In an embodiment of the present invention, when a plurality of objects is recognized, the user equipment control unit may suppress information leakage in accordance with the user input in a predetermined screen displayed on the user equipment display unit through a predetermined function.

In an embodiment of the present invention, the predetermined function may include at least one of a function of notifying the user that a face of a third party is detected, a function of displaying a color of an input keyboard displayed on the user equipment display unit to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment to a direction to block eyes of the third party.

According to another aspect of the present invention, a POS terminal includes a communication unit which receives feature information of an object corresponding to identification information of user equipment which visits a store equipped with the POS terminal, transmitted from a service providing device; a storing unit which temporarily store the received feature information of the object corresponding to the identification information of the user equipment; a recognizing unit which scans one or more products to be paid which are selected by a user of the user equipment; a display unit which displays product information on the scanned one or more products to be paid; a photographing unit which obtains image information including the user of the user equipment in a background state, while scanning the one or more products to be paid by means of the recognizing unit; and a control unit which recognizes one or more objects included in the image information by performing an object recognizing function on the obtained image information and checks whether a payment card is illegally used based on the feature information of the recognized one or more object and the feature information of the object corresponding to the identification information of the user equipment which is temporarily stored in the storing unit.

In an embodiment of the present invention, the control unit may extract feature information in the obtained image information and recognize one or more objects included in the image information based on the extracted feature information.

In an embodiment of the present invention, the control unit may calculate a similarity between the feature information of the recognized one or more objects and the feature information of the object corresponding to the identification information of the user equipment which is temporarily stored in the storing unit and check whether the calculated similarity is equal to or higher than a predetermined reference value.

In an embodiment of the present invention, when the calculated similarity is equal to or higher than the predetermined reference value, the control unit may determine that a payer who makes a payment matches a user which is registered in advance to control the communication unit to transmit one or more product information to be paid, identification information of the POS terminal, and the identification information of the user equipment to a payment server to perform a payment function by a predetermined payment method which is selected through a specific app which is installed in advance in the user equipment.

In an embodiment of the present invention, when the calculated similarity is lower than the predetermined reference value, the control unit may interlock with the user equipment to perform an additional authentication procedure.

According to another aspect of the present invention, a control method of user equipment includes: displaying a predetermined screen to receive information in accordance with user input by means of a user equipment display unit; obtaining surrounding and rear image information of the user in a state when a user of the user equipment watches a front camera when the predetermined screen is displayed on the user equipment display unit, by means of the front camera; recognizing one or more objects included in the image information by performing an object recognizing function on the obtained image information by means of a user equipment control unit; determining whether one object is included in the recognized image information, by means of the user equipment control unit; checking whether feature information of the recognized object is similar to feature information of a predetermined reference object when one object is included in the recognized image information, by means of the user equipment control unit; and suppressing information leakage in accordance with user input on a predetermined screen displayed on the user equipment display unit through a predetermined function by means of the user equipment control unit when a plurality of objects is included in the recognized image information as a determination result and/or feature information of the recognized object is not similar to the feature information of the predetermined reference object.

In an embodiment of the present invention, the control method may further include: returning to the obtaining of surrounding and rear image information of the user when the feature information of the recognized object is similar to the feature information of the predetermined reference object as the determination result; stopping an operation of the front camera, by means of the user equipment control unit when information in accordance with the user input is received; and transmitting the received information, information on a payment card corresponding to the information, and identification information of the user equipment to a service providing device, by means of the user equipment communication unit.

According to another aspect of the present invention, a computer program executing the methods according to the aforementioned embodiments may be stored in a non-transitory computer-readable storage medium storing a computer program recorded thereon.

According to the present invention, when privacy information, important information, or a password is input on a payment screen, a rear side of the user which cannot be watched by the user is monitored through a front camera equipped in user equipment to suppress a peeping situation by a third party and when a face of the third party is detected, it is notified to the user so that when a service such as payment or baking is used using mobile user equipment, a load of the user equipment may be reduced while increasing security.

Further, according to the present invention, the user is checked through a front camera on a payment screen and the user is basically discerned and the third party is checked using feature points of the face of the user, so that basic user authentication and suppressing of peeping by a third party may be performed without performing separate manipulation of the user.

Further, according to the present invention, a face of the user is analyzed using a camera configured in a POS terminal to check and discern whether the user joins as a member and image information obtained through the camera when the user makes a payment is stored as a record, so that illegal use of the payment card is suppressed and when the payment card is illegally used, the payment card may be tracked.

Further, according to the present invention, when a check-in procedure is performed through a beacon at the time of performing simple payment, information on a user of user equipment is detected to provide the information to the POS terminal and the user of the user equipment is discerned by the POS terminal. Therefore, even in a bad communication environment, the user may be effectively discerned and the security is improved and a terminal manipulating load of the user is reduced, thereby improving convenience.

### BRIEF DESCRIPTION OF THE DRAWINGS

FIG. 1 is a block diagram illustrating a configuration of a payment system according to an exemplary embodiment of the present invention.

FIG. 2 is a block diagram illustrating a configuration of user equipment according to an exemplary embodiment of the present invention.

FIG. 3 is a block diagram illustrating a configuration of another user equipment according to an exemplary embodiment of the present invention.

FIG. 4 is a block diagram illustrating a configuration of a POS terminal according to an exemplary embodiment of the present invention.

FIG. 5 is a flow chart illustrating a control method of a payment system according to a first exemplary embodiment of the present invention.

FIGS. 6 to 8 are views illustrating a screen of user equipment according to a first exemplary embodiment of the present invention.

FIGS. 9 and 11 are flow charts illustrating a control method of a payment system according to a second exemplary embodiment of the present invention.

FIG. 12 is a view illustrating a screen of user equipment according to a second exemplary embodiment of the present invention.

FIG. 13 is a view illustrating a screen of a POS terminal according to a second exemplary embodiment of the present invention.

### DETAILED DESCRIPTION OF THE PREFERRED EMBODIMENT

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

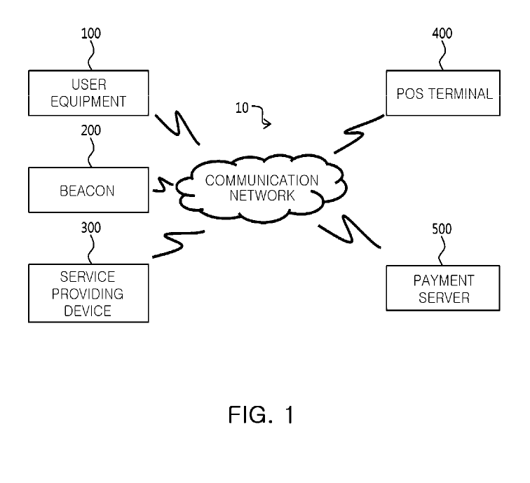

FIG. 1 is a block diagram illustrating a configuration of a payment system 10 according to an exemplary embodiment of the present invention.

As illustrated in FIG. 1, a payment system 10 is configured by user equipment 100, a beacon 200, a service providing device 300, a POS terminal 400, and a payment server 500. However, all the components of the payment system 10 illustrated in FIG. 1 are not essential components, but the payment system 10 may be implemented by more components or less components than the components illustrated in FIG. 1.

The user equipment 100 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, or a head mounted display (HMD)), a Wibro terminal, an internet protocol television (IPTV) terminal, a 3D television, a home theater system, an audio video navigation (AVN) terminal, an audio/video (A/V) system, or a flexible terminal.

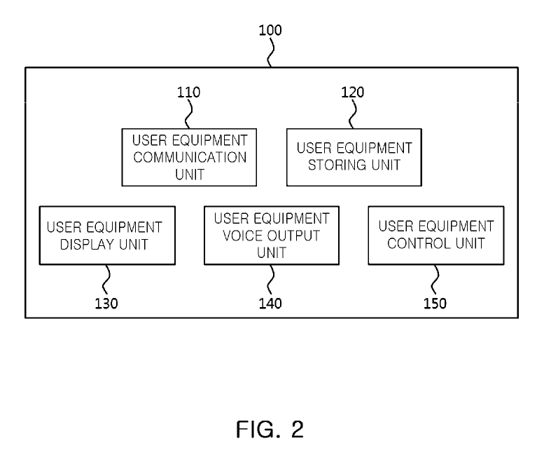

As illustrated in FIG. 2, the user equipment 100 is configured by a user equipment communication unit 110, a user equipment storing unit 120, a user equipment display unit 130, a user equipment voice output unit 140, and a user equipment control unit 150. However, all the components of the user equipment 100 illustrated in FIG. 2 are not essential components, but the user equipment 100 may be implemented by more components or less components than the components illustrated in FIG. 2.

The user equipment communication unit 110 connects an arbitrary internal component with at least one arbitrary external terminal through a wired/wireless communication network to communicate each other. In this case, the arbitrary external terminal may include the beacon 200, the service providing device 300, the POS terminal 400, and the payment server 500. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user equipment communication unit 110 transmits and receives data in accordance with at least one wireless Internet technique within a range including also Internet techniques which are not described above. Further, a short range communication technology may include Bluetooth, RFID (radio frequency identification), IrDA (infrared data association), UWB (ultra-wideband), ZigBee, NFC (near field communication), USC (ultra sound communication), VLC (visible light communication), Wi-Fi, Wi-Fi direct or the like. Furthermore, the wired communication technique may include power line communication (PLC), USB communication, Ethernet, serial communication, an optical/coaxial cable, or the like.

The user equipment communication unit 110 may transmit information with any terminal through a universal serial bus (USB).

The user equipment communication unit 110 transmits and receives a wireless signal to and from a base station, the beacon 200, the service providing device 300, the POS terminal 400, and the payment serve 500 on a mobile communication network built according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the user equipment communication unit 110 receives identification information (or unique identification information of a store provided with the beacon 200) of the beacon 200 which is transmitted from the beacon 200, by the control of the user equipment control unit 150.

The user equipment storing unit 120 stores various user interfaces UI and graphic user interfaces GUI.

Further, the user equipment storing unit 120 stores data and programs required to operate the user equipment 100.

That is, the user equipment storing unit 120 may store a plurality of application programs (or applications) which are driven in the user equipment 100 and data and commands for operation of the user equipment 100. At least some of the application programs may be downloaded from an external service providing device through wireless communication. Further, at least some of the application programs may be provided on the user equipment 100 since a releasing time in order to support a basic function (for example, phone call receiving and sending functions, message receiving and transmitting functions) of the user equipment 100. In the meantime, the application program is stored in the user equipment storing unit 120 and provided in the user equipment 100 to be driven to perform an operation (or a function) of the user equipment 100 by the user equipment control unit 150.

Further, the user equipment storing unit 120 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 100 may operate a web storage which performs a storing function of the user equipment storing unit 120 on the Internet or operate in association with the web storage.

Further, the user equipment storing unit 120 stores identification information (or unique identification information of a store provided with the beacon 200) of the beacon 200 which is received through the user equipment communication unit 110, by the control of the user equipment control unit 150.

The user equipment display device 130 may display various contents such as various menu screens using a user interface and/or graphic user interface stored in the user equipment storing unit 120, by the control of the user equipment control unit 150. Here, the contents displayed on the user equipment display unit 130 may include a menu screen including various texts, image data (including various information data), and data such as icons, list menus, or a combo boxes. The user equipment display unit 130 may be a touch screen.

Further, the user equipment display unit 130 may include at least one of a liquid crystal display (LCD), a thin film transistor liquid crystal display (TFT LCD), an organic light emitting diode (OLED), a flexible display, a field emission display (FED), a three dimensional display (3D display), an e-ink display, and a light emitting diode (LED).

Further, the user equipment display unit 130 may be configured as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

Further, the user equipment display unit 130 displays identification information (or unique identification information of a store provided with the beacon 200) of the beacon 200 which is received through the user equipment communication unit 110, by the control of the user equipment control unit 150.

The user equipment voice output unit 140 outputs voice information included in a signal processed by the user equipment control unit 150. Here, the user equipment voice output unit 140 may include a receiver, a speaker, a buzzer, and the like.

Further, the user equipment voice output unit 140 outputs a guide voice generated by the user equipment control unit 150.

Further, the user equipment voice output unit 140 outputs voice information corresponding to identification information (or unique identification information of a store provided with the beacon 200) of the beacon 200 which is received through the user equipment communication unit 110, by the control of the user equipment control unit 150.

The user equipment control unit 150 performs an overall control function of the user equipment 100.

The user equipment control unit 150 performs an overall control function of the user equipment 100 using a program and data stored in the user equipment storing unit 120. The user equipment control unit 150 may include a RAM, a ROM, a CPU, a GPU, and a bus and the RAM, the ROM, the CPU, and the GPU are connected to each other through the bus. The CPU accesses the user equipment storing unit 120 to perform booting using an O/S stored in the user equipment storing unit 120 and performs various operations using various programs, contents, and data stored in the user equipment storing unit 120.

Further, the user equipment control unit 150 interlocks with the service providing device 300 to perform a member joining procedure for the user of the user equipment 100.

When the member joining procedure is performed, the user equipment control unit 150 normally completes the member joining procedure for the service providing device 300 only by completing the authentication function through a self-authentication unit (for example, including a mobile phone, a credit card, I-PIN, e-mail, and the like).

Further, when a user who carries the user equipment 100 enters a store, the user equipment control unit 150 controls the user equipment communication unit 110 to receive the identification information (or unique identification information of a store provided with the beacon 200) of the beacon 200 transmitted from the beacon 200.

Further, the user equipment control unit 150 transmits the received unique identification information of the beacon 200 (or the unique identification information of a store provided with the beacon 200) and identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Further, when a user of the user equipment control unit 150 is not a member who is registered in advance in the service providing device 300, the user equipment control unit 150 performs the member joining procedure for the user equipment 100 (or a user of the user equipment 100) based on guide information related with the member joining procedure provided from the service providing device 300.

Further, when the user of the user equipment control unit 150 is a member who is registered in advance in the service providing device 300, the user equipment control unit 150 receives one or more advertisement information, one or more benefit information, or a recommended card list transmitted from the service providing device 300 in response to the transmitted unique identification information (or unique identification information of a store provided with the beacon 200) of the beacon 200 and the identification information of the user equipment 100 through the user equipment communication unit 110. Here, the benefit information includes coupon information, membership benefit information, and discount benefit information. Further, the recommended card list includes at least one card to which the benefit information is applied, among a plurality of cards (or one or more cards) which is issued in advance to the user equipment 100.

Further, the user equipment control unit 150 outputs at least one of the received advertisement information, benefit information, and recommended card list through the user equipment display unit 130 and/or the user equipment voice output unit 140.

Further, the user equipment control unit 150 checks one payment card (or unique identification information of the payment card) selected from the plurality of payment cards which is registered (or issued) in a specific app which is installed in advance in the user equipment 100.

The user equipment control unit 150 may checks the payment card selected from the recommended card list transmitted from the service providing device 300.

The user equipment control unit 150 may create the recommended card list including at least one card to which the benefit information may be applied, among a plurality of payment cards which is registered in advance in the user equipment 100, based on one or more benefit information provided from the service providing device 300 and display the created recommended card list on the user equipment display unit 130. Further, the user equipment control unit 150 may check one payment card selected from the recommended card list displayed on the user equipment display unit 130.

The user equipment control unit 150 receives a pin number (personal identification number) in accordance with the user input through a specific app which is installed in advance in the user equipment 100. Here, the PIN number may be a PIN number corresponding to the checked payment card type.

Further, the user equipment control unit 150 transmits the checked payment card type (or unique identification information of the payment card), the PIN number, and the identification information of the user equipment 100 to the service providing device 300 through the user equipment communication unit 110.

The user equipment control unit 150 receives a token transmitted from the service providing device 300 in response to the PIN number which is transmitted in advance, through the user equipment communication unit 110.

The user equipment control unit 150 creates a barcode (or a quick response code (QR code)) including the received token (or token information) and the identification information of the user equipment 100.

The user equipment control unit 150 stores the created barcode (or QR code) in the user equipment storing unit 120.

When a predetermined method is selected as a payment method through a specific app which is installed in advance in the user equipment 100, the user equipment control unit 150 transmits the barcode information (or the QR code information) corresponding to the barcode (or a QR code) which is previously created to the POS terminal 400 through the user equipment communication unit 110. Here, the barcode information corresponding to the barcode (or QR code information corresponding to the QR code) includes the token (or token information) or identification information of the user equipment 100. In this case, the payment method includes cash payment, credit card payment, or electronic payment and the predetermined method may be electronic payment.

As described above, when the user equipment 100 and the POS terminal 400 are connected through a wired/wireless communication scheme, the barcode information (or QR code information) may be transmitted from the user equipment 100 to the POS terminal 400.

In contrast, when the user equipment 100 and the POS terminal 400 are not connected through a wired/wireless communication scheme, if the user of the user equipment 100 selects a payment method which is previously set through a specific app which is installed in advance in the user equipment 100, a barcode (or a QR code) displayed on the user equipment display unit 130 may be recognized (scanned/tagged) by the POS terminal 400.

Further, after performing a payment function on one or more products to be paid which are selected by a user of the user equipment 100 based on the barcode information (or the QR code information) which is previously transmitted, the user equipment control unit 150 receives a payment function performing result transmitted from the POS terminal 400 (or the service providing device 300) through the user equipment communication unit 110 in response to the barcode information (or the QR code information) which is previously transmitted.

Further, the user equipment control unit 150 outputs the received payment function performing result through the user equipment display unit 130 and/or the user equipment voice output unit 140.

Further, the user equipment 100 may further include an interface unit (not illustrated) which functions as an interface with all external apparatuses which are connected to the user equipment 100. For example, the interface unit may be configured by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the user equipment 100 and may include a user identity module (UIM), a subscriber identity module (SIM), a universal subscriber identity module (USIM), and the like. Further, the device provided with the identification module may be prepared in a smart card form. Accordingly, the identification module may be connected with the user equipment 100 through the port. Such an interface unit receives data or power from an external device to transmit the received data or power to each component in the user equipment 100 or transmit the data in the user equipment 100 to the external device.

Further, the interface unit may be a passage through which the power from a cradle is supplied to the corresponding user equipment 100 when the user equipment 100 is connected to an external cradle or a passage through which various command signals input from the cradle by the user is transferred to the corresponding user equipment 100. Various command signals input from the cradle or the corresponding power may also operate by a signal for recognizing that the user equipment 100 is accurately installed on the cradle.

Further, the user equipment 100 may further include an input unit (not illustrated) for receiving a signal according to a button operation of the user or any function selection or receiving a command or a control signal created by an operation such as an operation of touching/scrolling the displayed screen.

The input unit is a means for receiving at least one of a user's command, selection, data, and information and may include a plurality of input keys and function keys for receiving figure or text information and setting various functions.

Further, the input unit may use various devices such as a key pad, a dome switch, a touch pad (a pressure resistive type/a capacitive resistive type), a touch screen, a jog wheel, a jog switch, a jog shuttle, a mouse, a stylus pen, and a touch pen. Particularly, when the user equipment display unit 130 is formed in a touch screen form, some or all of the input functions may be performed by the user equipment display unit 130.

Further, each component unit (or each module) of the user equipment 100 may be software stored on a memory (or the user equipment storing unit 120) of the user equipment 100. The memory may be an internal memory of the user equipment 100 and may an external memory or other types of storing devices. Further, the memory may be a non-volatile memory. The software stored on the memory may include a command set to allow the user equipment 100 to perform a specific operation while executing.

The beacon 200 communicates with the user equipment 100 and the POS terminal 400.

Further, the beacon 200 receives store information relate with the store provided with the beacon 200 or unique identification information of the store provided with the beacon 200 transmitted from the POS terminal 400.

The beacon 200 broadcasts (or transmits) store information or the identification information (or unique identification information of the store provided with the beacon 200) of the beacon 200.

The service providing device 300 communicates with the user equipment 100, the POS terminal 400, and the payment server 500.

Further, the service providing device 300 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the service providing device 300 interlocks with the user equipment 100 to perform a member joining procedure for the user of the user equipment 100.

Further, the service providing device 300 receives the unique identification information of the beacon 200 and the identification information of the user equipment 100 transmitted from the user equipment 100.

Further, the service providing device 300 determines (or checks) whether the user corresponding to the user equipment 100 is a member who is registered (joined) in advance in the service providing device 300 based on the received identification information of the user equipment 100.

When the user corresponding to the user equipment 100 is not a member who is registered in advance in the service providing device 300 as a determination result (or a checking result), the service providing device 300 transmits guide information related with the member joining procedure to the user equipment 100.

Further, the service providing device 300 interlocks with the user equipment 100 to perform a member joining procedure for the user equipment 100 (or the user of the user equipment 100).

Further, when the user corresponding to the user equipment 100 is a member who is registered in advance in the service providing device 300 as a determination result (or a checking result), the service providing device 300 checks one or more advertisement information and one or more benefit information which may be provided to the user equipment 100 in the store provided with the beacon 200, among a plurality of advertisement information and a plurality of benefit information which are stored in advance based on the unique identification information of the beacon 200 which is previously received and the identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, and discount benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

That is, when the user corresponding to the user equipment 100 is a member who is registered in advance in the service providing device 300, the service providing device 300 checks store information corresponding to the unique identification information of the beacon 200 among store information for every unique identification information of the plurality of beacons which is stored in advance. Further, the service providing device 300 checks one or more advertisement information and benefit information which may be provided to the user equipment 100 in the store based on the checked store information and the received identification information of the user equipment 100. Further, the service providing device 300 creates the recommended card list including at least one card to which the benefit information is applied, among a plurality of cards (or one or more cards) which is previously issued to the user equipment 100. Further, the service providing device 300 transmits one or more checked advertisement information, one or more checked benefit information, and the created recommended card list to the user equipment 100.

Further, the service providing device 300 receives the payment card type, the PIN number, and the identification information of the user equipment 100 transmitted from the user equipment 100.

Further, the service providing device 300 creates a token (a one-time token, token information, or temporary token) corresponding to the received PIN number. Here, the token is a temporary token and is randomly created corresponding to the PIN number. Further, a usage count or a usage duration may be set in advance. In this case, the service providing device 300 may create a token corresponding to the received PIN number and the payment card type.

Further, the service providing device 300 manages (or stores) the created token by interlocking with the payment card type, the PIN number, and the identification information of the user equipment 100.

Further, the service providing device 300 transmits the created token (or a token corresponding to the PIN number or a token corresponding to the PIN number and the payment card type) to the user equipment 100.

Further, the service providing device 300 receives the barcode information (or QR code information) transmitted from the payment server 500, to perform the authentication function for the user before performing the payment function on one or more products to be paid which are selected by the user of the user equipment 100.

Further, the service providing device 300 checks whether the token in the barcode information (or the QR code information) is valid, based on the token in the received barcode information (or QR code information) and the identification information of the user equipment 100.

That is, the service providing device 300 checks whether the token in the received barcode information (or QR code information), a token corresponding to the identification information of the user equipment 100, and identification information of the user equipment are included (or present) in the identification information of the user equipment for each of the plurality of tokens stored in advance (or issued in advance). As described above, the service providing device 300 may verify the validity of the issued token.

When the token in the received barcode information (or QR code information), the token corresponding to the identification information of the user equipment 100, and identification information of the user equipment are not included in the identification information of the user equipment for each of the plurality of tokens which is stored in advance in the service providing device 300 as a checking result, that is, when the token in the received barcode information (or the QR information) is not valid, the service providing device 300 transmits authentication failure information to the payment server 500.

When the token in the received barcode information (or QR code information), the token corresponding to the identification information of the user equipment 100, and identification information of the user equipment are included in the identification information of the user equipment for each of the plurality of tokens which is stored in advance in the service providing device 300 as a checking result, that is, when the token in the received barcode information (or the QR information) is valid, the service providing device 300 transmits card information, user information, benefit information corresponding to the identification information of the user equipment 100 in the received barcode information (or QR code information) to the payment server 500. In this case, the service providing device 300 may transmit card information, user information, and benefit information corresponding to the payment card type related with a valid token (or the payment card type checked based on the token created corresponding to the PIN number and the payment card type/PIN number is managed by interlocking with the token, payment card type, and payment card type checked based on the identification information of the user equipment) to the payment server 500. Here, the card information includes a card number, an expiration date, a card verification code (CVC) number, and a user name. The user information includes a user name, birth date, an address, and an image. Further, the benefit information includes coupon information, membership benefit information, and discount benefit information.

That is, when the token in the received barcode information (or QR code information) is valid as the checking result, the service providing device 300 checks the card information, the user information, and the benefit information stored in advance in the service providing device 300 related with the user (or the user equipment 100) corresponding to the identification information of the user equipment 100 in the received barcode information (or QR code information) and transmits the checked card information, user information, and benefit information to the payment server 500. In this case, the service providing device 300 checks the card information, the user information, and the benefit information corresponding to the payment card type which is previously transmitted from the user equipment 100 and transmits the checked card information, user information, and benefit information to the payment server 500.

Further, the service providing device 300 receives a payment function performed result (or payment information) transmitted from the payment server 500.

Further, the service providing device 300 stores the received payment function performed result by interlocking with the identification information of the user equipment 100.

Further, the service providing device 300 may transmit the received payment function performed result to the user equipment 100 corresponding to the identification information of the user equipment 100.

Further, the service providing device 300 may be implemented in a form such as a web server, a database server, and a proxy server. Further, in the service providing device 300, one or more of various software which allows a network load distribution mechanism or a service providing device 300 to operate on the Internet or other networks may be installed, and as a result, the service providing device 300 may be implemented by a computerized system. Further, the network may be an http network and may be a private line, Intranet, or any other networks. Furthermore, the service providing device 300 and the user equipment 100 may be connected to each other by a security network so as to suppress the data from being attacked by any hacker or other third parties. Further, the service providing device 300 may include a plurality of database servers. The database server may be implemented to be separately connected with the service providing device 300 through any type of network connection including a distributed database server architecture.

A processor mounted in the user equipment 100 or the service providing device 300 according to the exemplary embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storing device.

The point of sales (POS) terminal 400 communicates with the user equipment 100, the beacon 200, the service providing device 300, and the payment server 500.

Further, the POS terminal 400 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the POS terminal 400 transmits store information relate with the store provided with the beacon 200 or unique identification information of the store provided with the beacon 200 to the beacon 200.

The POS terminal 400 scans (or recognizes a barcode attached on a product to be paid) one or more products (or payment products) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

In contrast, when the user equipment 100 and the POS terminal 400 are not connected through a wired/wireless communication scheme, if the user of the user equipment 100 selects a payment method which is previously set through a specific app which is installed in advance in the user equipment 100, the POS terminal 400 recognizes (or scans/tags) a barcode (or a QR code) displayed on the user equipment display unit 130.

Further, the POS terminal 400 receives the barcode information (or the QR code information) transmitted from the user equipment 100.

When the POS terminal 400 recognizes a barcode (or a QR code) displayed on the user equipment 100, the POS terminal 400 checks the recognized barcode information (or the QR code information).

The POS terminal 400 displays or stores the received (or checked) barcode information (or QR code information).

The POS terminal 400 transmits information on one or more products to be paid (or recognized product information to be paid), barcode information (or QR code information), and the identification information of the POS terminal 400 to the payment server 500.

The POS terminal 400 may receive authentication failure information transmitted from the payment server 500 in response to the barcode information (or QR code information) transmitted to the payment server 500.

The POS terminal 400 displays the received authentication failure information.

Further, the POS terminal 400 may transmit the received authentication failure information to the user equipment 100.

Further, the POS terminal 400 receives user information transmitted from the payment server 500 immediately before performing a payment function on one or more products selected by the user of the user equipment 100 based on the barcode information (or QR code information) transmitted to the payment server 500. Here, the user information includes a user name, birth data, address, and an image related with the user corresponding to the identification information of the user equipment 100.

The POS terminal 400 displays the received user information. Further, the user of the POS terminal 400 checks an image in the user information displayed on the POS terminal 400 and the user of the user equipment 100 which makes a payment on the product. Thereafter, when the image in the user information matches the user of the user equipment 100, the POS terminal 400 receives information indicating the user matching in accordance with the user input of the POS terminal 400.

The POS terminal 400 transmits received information indicating the user matching, and identification information of the POS terminal 400 to the payment server 500.

Further, when a payment function on one or more products selected by the user of the user equipment 100 is normally performed based on the barcode information (or QR code information) transmitted to the payment server 500, the POS terminal 400 receives a payment function performed result (or payment information) which is transmitted from the payment server 500 in response to the barcode information (or the QR code information) transmitted to the payment server 500. Here, the payment function performed result (or the payment information) includes a product name, a unique product code, a unit price, an amount, a discounted price, whether to apply a coupon, a price, a total price, payment date and time information, and a payment card type.

The POS terminal 400 transmits the received payment function performed result to the user equipment 100.

Further, the POS terminal 400 may output the received payment function performed result through a printed matter such as a receipt.

The payment server 500 communicates with the user equipment 100, the service providing device 300, and the POS terminal 400.

Further, the payment server 500 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

The payment server 500 receives information on one or more products to be paid (or recognized product information to be paid), barcode information (or QR code information), and the identification information of the POS terminal 400 transmitted from the POS terminal 400.

Further, the payment server 500 transmits the received barcode information (or QR code information) to the service providing device 300 in order to perform an authentication procedure related with the user equipment 100.

When the token in the barcode information (or the QR information) which is transmitted to the service providing device 300 is not valid, the payment server 500 receives authentication failure information which is transmitted from the service providing device 300 in response to the barcode information (or the QR information) which is transmitted to the service providing device 300.

Further, the payment server 500 transmits the received authentication failure information to the POS terminal 400.

When the token in the barcode information (or the QR information) which is transmitted to the service providing device 300 is valid, the payment server 500 receives card information, user information, or benefit information (or card information, user information, or benefit information corresponding to the identification information of the user equipment 100 in the barcode information (or the QR information)) which is transmitted from the service providing device 300 in response to the barcode information (or the QR information) which is transmitted to the service providing device 300.

The payment server 500 performs a payment function on the payment amount corresponding to one or more product information to be paid based on the received card information, user information, and benefit information. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

In this case, immediately before performing the payment function, the payment server 500 transmits the user information transmitted from the service providing device 300 to the POS terminal 400.

When the image in the user information does not match the user of the user equipment 100 who make a payment on the product, the payment server 500 transmits payment cancel information on the one or more product information to the POS terminal 400 or performs the payment function after performing additional authentication procedure on the user equipment 100.

When the image in the user information matches the user of the user equipment 100 who make a payment on the product, the payment server 500 receives the information indicating that the user matches the image transmitted from the POS terminal 400 and the identification information of the POS terminal 400, in response to the user information transmitted to the POS terminal 400.

The payment server 500 performs a payment function on the payment amount corresponding to one or more product information to be paid based on the received card information, user information, benefit information, and the information indicating that the user matches the image.

The payment server 500 transmits the payment function performed result (or payment information) to the POS terminal 400 and the service providing device 300. Here, the payment function performed result (or the payment information) includes a product name, a unique product code, a unit price, an amount, a discounted price, whether to apply a coupon, a price, a total price, payment date and time information, and a payment card type.

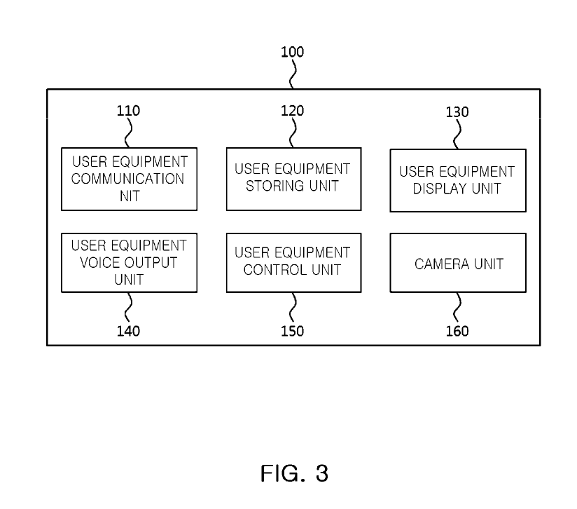

FIG. 3 is a block diagram illustrating a configuration of user equipment according to another exemplary embodiment of the present invention.

As illustrated in FIG. 3, the user equipment 100 is configured by a user equipment communication unit 110, a user equipment storing unit 120, a user equipment display unit 130, a user equipment voice output unit 140, a user equipment control unit 150, and a camera unit 160. However, all the components of the user equipment 100 illustrated in FIG. 3 are not essential components, but the user equipment 100 may be implemented by more components or less components than the components illustrated in FIG. 3.

When a predetermined screen including a screen for receiving a PIN number to receive information in accordance with user input (or user selection), a screen for receiving a payment card number, a screen for receiving a security card number, and a screen for receiving personal information is displayed, the user equipment 100 obtains image information through a front camera 161 equipped in the user equipment 100. Thereafter, the user equipment 100 performs an object recognizing function on the obtained image information to recognize one or more objects included in the image information. Thereafter, when there is a single recognized object and feature information of the recognized object is similar to feature information of a predetermined reference object, the user equipment 100 confirms to be a normal state. Further, when a plurality of objects is recognized or a single object is recognized and feature information of the recognized object is not similar to feature information of the predetermined reference object, the user equipment 100 determines that there is worry about leakage of information in accordance with the user input so that the information leakage on the screen in accordance with the user input is suppressed through a predetermined function.

As illustrated in FIG. 2, the user equipment 100 is configured by a user equipment communication unit 110, a user equipment storing unit 120, a user equipment display unit 130, a user equipment voice output unit 140, and a user equipment control unit 150.

When a predetermined screen is displayed on the user equipment display unit 130 to receive information in accordance with the user input (or user selection), the user equipment control unit 150 controls the front camera 161 to obtain image information through the front camera 161. In this case, the image information obtained through the front camera 161 may be front image information (or surrounding and/or rear image information of the user including the user (or a face of the user) in a state when the user of the user equipment 100 watches the front camera 161) of the front camera 161. Here, after selecting a payment card, the predetermined screen includes a PIN number receiving screen for receiving a PIN number in accordance with user input (or user selection) in accordance with the selected payment card, a payment card number receiving screen for receiving payment card information (or payment card number) in accordance with the user input (or user selection), a security card number receiving screen for receiving a security card number in accordance with the user input (or user selection), and a personal information receiving screen for receiving personal information (for example, including a name, a birth date, and an address) in accordance with the user input (or user selection).

Further, the user equipment control unit 150 may display image information obtained through the front camera 161 in one region of a predetermined screen displayed on the user equipment display unit 130.

Further, the user equipment control unit 150 performs an object recognizing function on the obtained image information.

That is, the user equipment control unit 150 extracts (or calculates) feature information in the obtained image information.

Further, the user equipment control unit 150 recognizes (or discerns) one or more objects included in the image information based on the extracted feature information.

Further, the user equipment control unit 150 determines (or checks) whether another user is included in one or more objects included in the recognized image information in addition to a pre-registered user (or object).

That is, the user equipment control unit 150 determines (or checks) whether one object is included in the image information (or whether a plurality of objects is included in the image information).

When the plurality of objects is included in the image information as a determination result, the user equipment control unit 150 suppresses information leakage in accordance with the user input (or user selection) on the predetermined screen through a predetermined function. Here, the predetermined function includes a function of notifying the user that a face of a third party is detected, a function of displaying a color of an input keyboard displayed on the user equipment 100 to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment 100 to a direction to block eyes of the third party.

Further, the user equipment control unit 150 repeatedly performs a process of obtaining image information through the front camera 161, a process of recognizing an object in the image information, and a process of determining whether a user for the recognized object is real until information in accordance with user input (or user selection) in a previous step is completely received.

Further, when one object is included in the image information as a determination result, the user equipment control unit 150 checks (or determines) whether feature information of the recognized object is similar to feature information of the predetermined reference object. Here, the feature information of the predetermined reference object may be feature information related with the user of the user equipment 100.

That is, when one object is included in the image information as a determination result, the user equipment control unit 150 calculates a similarity between the feature information of the recognized object and the feature information of the predetermined reference object. Further, the user equipment control unit 150 checks whether the calculated similarity (or similarity of feature information between two objects) is equal to or higher than a predetermined reference value.

When the feature information of the recognized object is similar to the feature information of the predetermined reference object (or the calculated similarity of feature information between two objects is equal to or higher than the predetermined reference value) as a checking result, the user equipment control unit 150 confirms to be a normal state and repeatedly performs the process of obtaining image information through the front camera 161, the process of recognizing an object in the image information, and a process of determining whether a user for the recognized object is real until information in accordance with user input (or user selection) in a previous step is completely received.

As described above, a face of the user is checked from the image information and is compared with the feature information of a reference object which is stored in advance to check whether the user is a predetermined reference object (or a predetermined user of the user equipment 100) without performing separate user manipulation.

Further, when the feature information of the recognized object is not similar to the feature information of the predetermined reference object (or the calculated similarity of feature information between two objects is lower than the predetermined reference value) as the checking result, the user equipment control unit 150 suppresses information leakage on the predetermined screen in accordance with user input (or user selection) through a predetermined function. Here, the predetermined function includes a function of notifying the user that a face of a third party is detected, a function of displaying a color of an input keyboard displayed on the user equipment 100 to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment 100 to a direction to block eyes of the third party.

Further, the user equipment control unit 150 repeatedly performs a process of obtaining image information through the front camera 161, a process of recognizing an object in the image information, and a process of determining whether a user for the recognized object is real until information in accordance with user input (or user selection) in a previous step is completely received.

Further, since image information may be provided through a screen of another user equipment or an authentication process may be passed (or performed) through a photo, the user equipment control unit 150 basically checks whether there is face motion or eye blinking through a change of the image information to figure out the image is a photo or determines whether a pixel is detected or reflected light is detected in the obtained image information to figure out whether the image information or a moving image is input through another terminal.

Further, since a user may be replaced by another user after passing the authentication process, the user equipment control unit 150 continuously and repeatedly performs a user authentication procedure such as a process of obtaining image information, a process of recognizing an object in the image information, and a process of determining whether a user for the recognized object is real until information corresponding to a predetermined screen is received.

Further, when information in accordance with the user input (or user selection) is received, the user equipment control unit 150 ends a process of obtaining image information through the front camera 161 (or an image information obtaining process, an object recognizing process, and a process of determining whether a user for the recognized object is real) (or stops (or turns off) an operation of the front camera 161) and transmits the received information and identification information of the user equipment 100 to the service providing device 300 through the user equipment communication unit 110.

Further, the user equipment control unit 150 interlocks with the service providing device 300, the POS terminal 400, and the payment server 500 to perform a payment function on one or more products to be paid (or payment product) which are selected to be purchased in the store by the user of the user equipment 100.

The camera unit 160 includes a front camera 161 and a rear camera 162 which are configured on at least one surface of the user equipment 100. Here, the front camera 161 is located on a surface on which a main screen is displayed. When a plurality of user equipment display units 130 is provided, the front camera 161 is formed on the same plane as a main user equipment display unit 130 among the plurality of user equipment display unit 130. Further, the rear camera 161 is formed to be opposite to the front camera 161 formed in the user equipment 100.

Further, the camera unit 160 processes an image frame such as a still image or a moving image obtained by an image sensor (or a camera module or a camera) in a video call mode, a photographic mode, or a conference call mode. That is, image data obtained by the image sensor in accordance with a CODEC is encoded/decoded to satisfy a standard. The processed image frame may be displayed on the display unit 140 by the control of the user equipment control unit 150. For example, the camera unit 160 photographs an object (or a subject) (an user image or an image conferee) and outputs a video signal corresponding to the photographed image (a subject image).

The image frame processed in the camera unit 160 may be stored in the user equipment storing unit 120 or transmitted to an external terminal (including an arbitrary conference call terminal included in a conference call system) through the user equipment communication unit 110.

Further, a lens unit (not illustrated) to photograph an enlarged image may be provided in an upper portion of the camera unit 160.

Further, the camera unit 160 photographs image information by the control of the user equipment control unit 150. In this case, the image information photographed by the camera unit 160 may include an object.

That is, when a predetermined screen is displayed on the user equipment 100 to receive information in accordance with the user input (or user selection), the front camera 161 operates by the control of the user equipment control unit 150 and obtains the image information. In this case, the image information obtained through the front camera 161 may be front image information (or surrounding and/or rear image information of the user including the user (or a face of the user) in a state when the user of the user equipment 100 watches the front camera 161) of the front camera 161.

Further, when information in accordance with the user input (or use selection) is received in the predetermined screen, an operation of the front camera 161 is stopped (or turned off) by the control of the user equipment control unit 150.

Further, a payment system 10 according to another exemplary embodiment of the present invention will be configured below.

That is, when a user who carries the user equipment 100 enters a store, the POS terminal equipped in the store temporarily stores feature information of a reference object corresponding to identification information of the user equipment provided from the service providing device 300. Thereafter, the POS terminal 400 recognizes a scanned product to be paid with respect to one or more products to be paid which are selected by the user of the user equipment 100 and obtains image information including the user of the user equipment 100 and recognizes an object in the obtained image information. Thereafter, the POS terminal 400 performs an additional authentication procedure depending on a result of checking whether the feature information of the recognized object is similar to feature information of a reference object corresponding to the identification information of the user equipment 100 which is previously temporarily stored, and then transmits one or more product information to be paid, identification information of the user equipment 100, and identification information of the POS terminal to the payment server 500 to perform a payment function in accordance with a predetermined payment method selected through a specific app which is installed in advance in the user equipment 100. Thereafter, the payment server 500 transmits the identification information of the user equipment 100 to the service providing device 300. Thereafter, the service providing device 300 transmits card information, user information, and benefit information corresponding to the identification information of the user equipment 100 transmitted from the payment server 500 to the payment server 500. Thereafter, the payment server 500 performs a payment function on a payment amount on one or more products to be paid based on the card information, the user information, and the benefit information transmitted from the service providing device 300 in response to the identification information of the user equipment which is previously transmitted and provides a payment function performed result to the user equipment 100 through the POS terminal 400.

After the user who carries the user equipment 100 enters a store, in order to perform a simple payment function, the user equipment 100 selects one or more payment cards, receives a PIN number corresponding to the selected payment card in accordance with the user input (or user selection), and transmits information on the payment card (or information on a type of the payment card), the PIN number corresponding to the payment card, and identification information of the user equipment 100 to the service providing device 300.

Further, when a predetermined method (or a predetermined payment method) is selected as a payment method through a specific app which is installed in advance in the user equipment 100, the user equipment 100 transmits payment request information through a predetermined payment method to the POS terminal 400 to perform a payment function on one or more products to be paid which are selected by the user of the user equipment 100.

Further, when additional authentication is requested in the POS terminal, the user equipment 100 interlocks with the POS terminal 400 to perform an additional authentication function (for example, phone authentication or payment card checking).

After normally performing the payment function on previously selected one or more products, the user equipment 100 receives a payment function performed result transmitted from the POS terminal 400.

Further, the user equipment 100 displays the received payment function performed result.

The service providing device 300 communicates with the user equipment 100, the POS terminal 400, and the payment server 500.

After the user who carries the user equipment 100 enters a store, in order to perform a simple payment function, the service providing device 300 receives information on the payment card (or information on a type of the payment card), the PIN number corresponding to the payment card, and identification information of the user equipment 100 transmitted from the user equipment 100.

Further, the service providing device 300 maintains a stand-by status (or check-in status) for simple payment.

Further, the service providing device 300 checks feature information of a reference object (or the user of the user equipment 100) corresponding to the identification information of the user equipment 100 among feature information of a plurality of objects for every user equipment which is stored in advance and transmits the feature information of the reference object corresponding to the checked identification information of the user equipment 100 to the POS terminal 400 related with unique identification information of the beacon 200.

Further, the service providing device 300 checks information on the payment card related with the user equipment 100 and the PIN number based on the identification information of the user equipment 100 transmitted from the payment server 500 and transmits the card information, the user information, and the benefit information corresponding to the received identification information of the user equipment 100 and the checked information on the payment card (or a payment card/a payment card type) to the payment server 500.

The POS terminal 400 communicates with the user equipment 100, the service providing device 300, and the payment server 500.

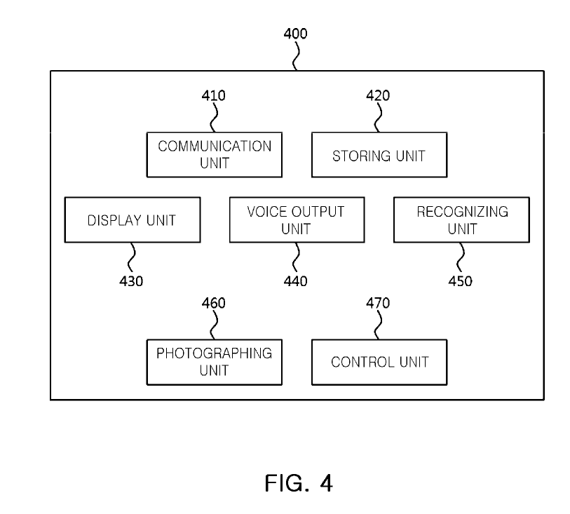

FIG. 4 is a block diagram illustrating a configuration of a POS terminal 400 according to an exemplary embodiment of the present invention.

As illustrated in FIG. 4, the POS terminal 400 is configured by a communication unit 410, a storing unit 420, a display unit 430, a voice output unit 440, a recognizing unit 450, a photographing unit 460, and a control unit 470. However, all the components of the POS terminal 400 illustrated in FIG. 4 are not essential components, but the POS terminal 400 may be implemented by more components or less components than the components illustrated in FIG. 4.

The communication unit 410 connects an arbitrary internal component with at least one external terminal through a wired/wireless communication network to communicate each other. In this case, the arbitrary external terminal may include the user equipment 100, the beacon 200, the service providing device 300, and the payment server 500. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The communication unit 410 transmits and receives data in accordance with at least one wireless Internet technique within a range including Internet techniques which are not listed above. Further, a near field communication technology may include Bluetooth, radio frequency identification (RFID), infrared data association (IrDA), ultra-wideband (UWB), ZigBee, near field communication (NFC), ultra sound communication (USC), visible light communication (VLC), Wi-Fi, and Wi-Fi direct. Further, a wired communication technology may include power line communication (PLC), USB communication, Ethernet, serial communication, or an optical/coaxial cable.

The communication unit 410 may transmit information with any terminal through a universal serial bus (USB).

The communication unit 1410 transmits and receives a wireless signal to and from a base station, the user equipment 100, the beacon 200, the service providing device 300, and the payment serve 500 on a mobile communication network built according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the communication unit 410 receives feature information of the reference object related with the user of the user equipment 100 who enters (or visits) a store equipped with the POS terminal 400 transmitted from the service providing device 300 by the control of the control unit 470.

The storing unit 420 stores various user interfaces UI and graphic user interfaces GUI.

Further, the storing unit 420 stores data and programs required for operating the POS terminal 400.

That is, the storing unit 420 may store a plurality of application programs (or applications) which are driven in the POS terminal 400 and data and commands for operation of the POS terminal 400. At least some of the application programs may be downloaded from an external service providing device through wireless communication. In the meantime, the application program is stored in the storing unit 420 and installed in the POS terminal 400 to be driven to perform an operation (or a function) of the POS terminal 400 by the control unit 470.

Further, the storing unit 420 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the POS terminal 400 may operate a web storage which performs a storing function of the storing unit 420 on the Internet or operate in association with the web storage.

Further, the storing unit 420 temporarily stores feature information (or feature information of a reference object corresponding to the identification information of the use equipment 100) of the reference object received through the communication unit 410 by the control of the control unit 470.

The display device 430 may display various contents such as various menu screens using a user interface and/or graphic user interface stored in the storing unit 420, by the control of the control unit 470. Here, the contents displayed on the display unit 430 may include a menu screen including various texts, image data (including various information data), and data such as icons, list menus, or a combo boxes. The display unit 430 may be a touch screen.

Further, the display unit 430 may include at least one of a liquid crystal display (LCD), a thin film transistor liquid crystal display (TFT LCD), an organic light emitting diode (OLED), a flexible display, a three dimensional display, an e-ink display, and a light emitting diode (LED).

Further, the display unit 430 may be configured as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

Further, the display unit 430 displays the feature information of the reference object related with the user of the user equipment 100 received through the communication unit 410 by the control of the control unit 470.

The voice output unit 140 outputs voice information included in a signal processed by the control unit 150. Here, the voice output unit 140 may include a receiver, a speaker, a buzzer, and the like.

Further, the voice output unit 140 outputs a guide voice generated by the control unit 150.

Further, the voice output unit 140 outputs voice information corresponding to the feature information of the reference object related with the user of the user equipment 100 received through the communication unit 410 by the control of the control unit 150.

The recognizing unit (or a tagging unit) scans (or recognizes a barcode attached on a product to be paid) one or more products (or payment products) to be paid which are selected by the user of the user equipment 100.

Further, the recognizing unit 450 outputs product information on previously scanned (or recognized) one or more products to be paid by the control of the control unit 470, through the display unit 430 and/or the voice output unit 440.

The photographing unit (or the camera unit) 460 includes one or more cameras provided on at least one surface of the POS terminal 400.

Further, the photographing unit 460 processes an image frame such as a still image or a moving image obtained by an image sensor (or a camera module or a camera) in a video call mode, a photographic mode, or a conference call mode. That is, image data obtained by the image sensor in accordance with a CODEC is encoded/decoded to satisfy a standard. The processed image frame may be displayed on the display unit 140 by the control of the control unit 470. For example, the photographing unit 460 photographs an object (or a subject) (an user image or an image conferee) and outputs a video signal corresponding to the photographed image (a subject image).

The image frame processed in the photographing unit 460 may be stored in the storing unit 420 or transmitted to an external terminal (including an arbitrary conference call terminal included in a conference call system) through the communication unit 410.

Further, a lens unit (not illustrated) to photograph an enlarged image may be provided in an upper portion of the photographing unit 460.

Further, the photographing unit 460 photographs image information by the control of the control unit 470. In this case, the image information which is photographed by the photographing unit 460 may include objects located on a front surface and a side surface of the POS terminal 400 to make a payment.

That is, the product to be paid among one or more products to be paid selected by the user of the user equipment 100 is scanned through the recognizing unit 450 and image information including the user of the user equipment 100 is obtained (or photographed) through the photographing unit 460 in a background state.

The control unit 470 performs an overall control function of the POS terminal 400.

The control unit 470 performs an overall control function of the POS terminal 400 using a program and data stored in the storing unit 420. The control unit 470 may include a RAM, a ROM, a CPU, a GPU, and a bus and the RAM, the ROM, the CPU, and the GPU are connected to each other through the bus. The CPU accesses the storing unit 420 to perform booting using an O/S stored in the storing unit 420 and performs various operations using various programs, contents, and data stored in the storing unit 40.

Further, the control unit 470 performs an object recognizing function on the image information obtained through the photographing unit 460.

That is, the control unit 470 extracts (or calculates) feature information in the obtained image information.

Further, the control unit 470 recognizes (or discerns) one or more objects included in the image information based on the extracted feature information.

Further, the control unit 470 checks (or determines) whether feature information of the recognized object is similar to the feature information of the reference object corresponding to the identification information of the user equipment 100 provided from the service providing device 300. Here, the feature information of the predetermined reference object may be feature information related with the user of the user equipment 100.

That is, the control unit 470 calculates a similarity between the feature information of the recognized object and the feature information of the reference object corresponding to the identification information of the user equipment 100. Further, the control unit 470 checks (or determines) whether the calculated similarity (or similarity of feature information between two objects) is equal to or higher than a predetermined reference value.

When the feature information of the recognized object is similar to the feature information of the reference object corresponding to the identification information of the user equipment 100 (or the calculated similarity of the feature information between two objects is equal to or higher than a predetermined reference value) as a checking result, the control unit 470 determines that a payer who makes a payment matches the previously registered user and transmits one or more product information to be paid (or recognized product information to be paid), identification information of the POS terminal 400, and the identification information of the user equipment 100 to the payment server 500 through the communication unit 410, in order to perform a payment function in accordance with a predetermined payment method which is selected by a specific app which is installed in advance in the user equipment 100. In this case, the payment method includes cash payment, credit card payment, or electronic payment and the predetermined payment method may be electronic payment.

Further, when the feature information of the recognized object is not similar to the feature information of the reference object corresponding to the identification information of the user equipment 100 (or the calculated similarity of the feature information between two objects is lower than a predetermined reference value) as the checking result, the control unit 470 determines that the payer who makes a payment does not match the previously registered user and requests additional authentication to the user equipment 100 in order to suppress illegal use of the payment card.

Further, the control unit 470 interlocks with the user equipment 100 to perform the additional authentication function (for example, including phone authentication or payment card checking) based on the previously requested additional authentication.

Further, when the feature information of the recognized object is not similar to the feature information of the reference object corresponding to the identification information of the user equipment 100 (or the calculated similarity of the feature information between two objects is lower than a predetermined reference value) as the checking result, the control unit 470 determines that the payment card is illegally used to generate authentication failure information (or payment failure information) and transmit the generated authentication failure information to the user equipment 100 through the communication unit 410. The user equipment 100 receives the authentication failure information transmitted from the POS terminal 400 and displays the received authentication failure information.

After normally performing additional authentication procedure between the POS terminal 400 and the user equipment 100, the control unit 470 transmits one or more product information to be paid (or recognized product information to be paid), the identification information of the POS terminal 400, and the identification information of the user equipment 100 to the payment server 500 through the communication unit 410, in order to perform a payment function in accordance with a predetermined payment method which is selected by a specific app which is installed in advance in the user equipment 100. In this case, the payment method includes cash payment, credit card payment, or electronic payment and the predetermined payment method may be electronic payment.

Further, the control unit 470 receives a payment function performed result transmitted from the payment server 500 through the communication unit 410.

Further, the control unit 470 transmits the received payment function performed result to the user equipment 100 through the communication unit 410.

Further, the control unit 470 outputs the received payment function performed result through a printed matter such as a receipt.

Further, the control unit 470 outputs the received payment function performed result through the display unit 430 and/or the voice output unit 440.

After completing the payment function related with the user equipment 100, the control unit 470 deletes the feature information of the object corresponding to the identification information of the user equipment 100 which is temporarily stored in the storing unit 420.

The payment server 500 communicates with the user equipment 100, the service providing device 300, and the POS terminal 400.

The payment server 500 receives information on one or more products to be paid (or recognized product information to be paid) transmitted from the POS terminal 400, the identification information of the POS terminal 400, and the identification information of the user equipment 100.

Further, the payment server 500 transmits the identification information of the user equipment 100 in order to perform an authentication procedure related with the user equipment 100.

Further, the payment server 500 receives card information, user information, and benefit information which are transmitted from the service providing device 400 in response to the identification information of the user equipment 300 which is previously transmitted.

The payment server 500 performs a payment function on the payment amount corresponding to one or more product information to be paid based on the received card information, user information, and benefit information. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

The payment server 500 transmits the payment function performed result (or payment information) to the POS terminal 400 and the service providing device 300. Here, the payment function performed result (or the payment information) includes a product name, a unique product code, a unit price, an amount, a discounted price, whether to apply a coupon, a price, a total price, payment date and time information, and a payment card type.

As described above, when personal information, important information, or a password is input on a payment screen, a rear side of a user which cannot be watched by the user is monitored through a front camera equipped in user equipment to suppress a peeping situation by a third party and the user is notified that a face of the third party is detected.

Further, as described above, the user is checked on the payment screen through the front camera to simultaneously basically discern the user and check a third party using feature points of a face of the user.

Furthermore, a face of the user is analyzed by a camera configured in the POS terminal to check and discern whether the user joins as a member and the image information obtained through the camera at the time of making a payment may be stored as a record.

Further, as described above, when a check-in process is performed through a beacon at the time of performing simple payment, information on the user of the user equipment is detected in advance to be provided to the POS terminal and the user of the user equipment may be discerned by the POS terminal.

Hereinafter, a control method of a payment system according to an exemplary embodiment of the present invention will be described in detail with reference to FIGS. 1 to 13.

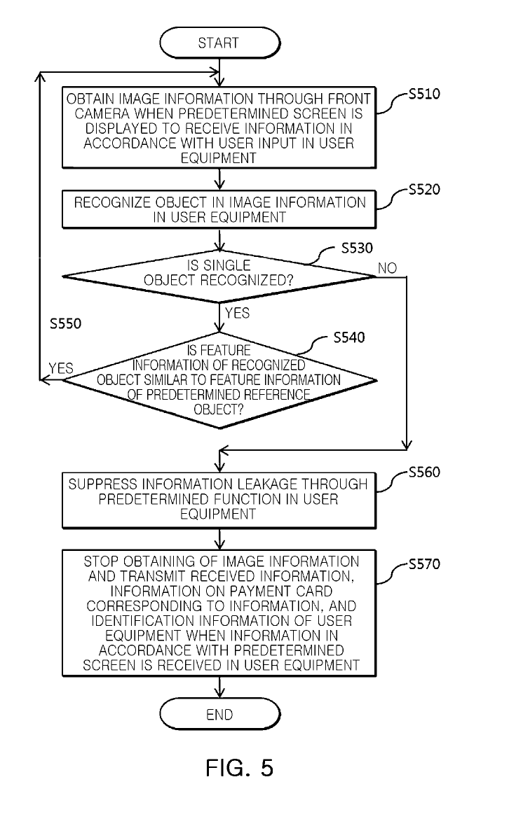

FIG. 5 is a flow chart illustrating a control method of a payment system according to a first exemplary embodiment of the present invention.

That is, when a predetermined screen is displayed on the user equipment 100 to receive information in accordance with the user input (or user selection), the user equipment 100 obtains image information through a front camera 161 included in the user equipment 100. In this case, the image information obtained through the front camera 161 may be front image information (or surrounding and/or rear image information of the user including the user (or a face of the user) in a state when the user of the user equipment 100 watches the front camera 161) of the front camera 161. Here, after selecting a payment card, the predetermined screen includes a PIN number receiving screen for receiving a PIN number in accordance with user input (or user selection) in accordance with the selected payment card, a payment card number receiving screen for receiving payment card information (or payment card number) in accordance with the user input (or user selection), a security card number receiving screen for receiving a security card number in accordance with the user input (or user selection), and a personal information receiving screen for receiving personal information (for example, including a name, a birth date, and an address) in accordance with the user input (or user selection).

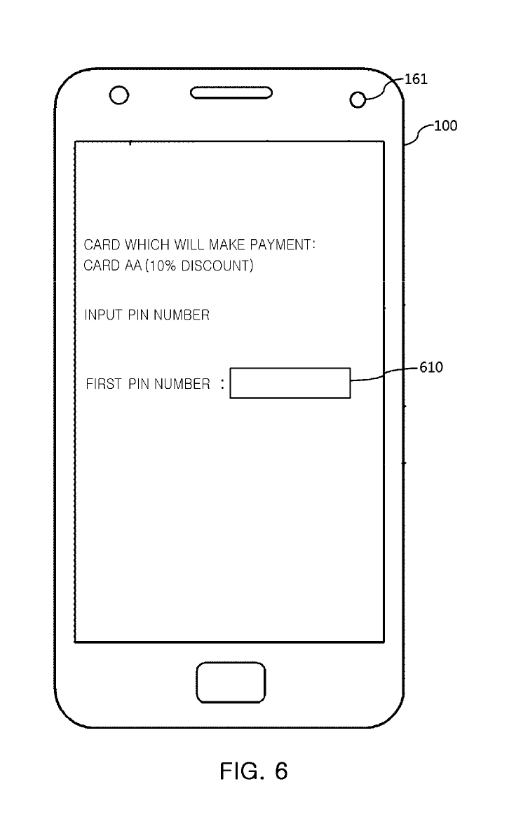

For example, when a payment card AA is selected among a plurality of payment cards registered in the user equipment 100 for simple payment and as illustrated in FIG. 6, a first PIN number receiving screen 610 is displayed to receive a first PIN number in accordance with user input corresponding to the selected payment card AA, the user equipment 100 obtains first image information which includes a user who carries the user equipment 100, through the front camera 161 included in the user equipment 100.

As another example, when a payment card BB is selected among a plurality of payment cards registered in the user equipment 100 for simple payment and a second PIN number receiving screen is displayed to receive a second PIN number in accordance with user input corresponding to the selected payment card BB, the user equipment 100 obtains second image information which includes a user who carries the user equipment 100 and another user who is located at the back of the user, through the front camera 161 included in the user equipment 100 (S510).

Thereafter, the user equipment 100 performs an object recognizing function on the obtained image information.

That is, the user equipment 100 extracts (or calculates) feature information in the obtained image information.

Further, the user equipment 100 recognizes (or discerns) one or more objects included in the image information based on the extracted feature information.

For example, the user equipment 100 extracts feature information in the obtained first image information and recognizes a first object (or an object corresponding to a user who carries the user equipment 100) included in the first image information based on the extracted feature information.

As another example, the user equipment 100 extracts feature information in the obtained second image information and recognizes a first object and a second object included in the second image information based on the extracted feature information (S520).

Next, the user equipment 100 determines (or checks) whether another user is included in one or more objects included in the recognized image information in addition to a pre-registered user (or object).

That is, the user equipment 100 determines (or checks) whether one object is included in the image information (or whether a plurality of objects is included in the image information).

For example, the user equipment 100 determines whether one object is recognized in the first image information.

As another example, the user equipment 100 determines whether one object is recognized in the first image information (S530).

When one object is included in the image information as a determination result, the user equipment 100 checks (or determines) whether feature information of the recognized object is similar to feature information of the predetermined reference object. Here, the feature information of the predetermined reference object may be feature information related with the user of the user equipment 100.

That is, when one object is included in the image information as a determination result, the user equipment 100 calculates a similarity between the feature information of the recognized object and the feature information of the predetermined reference object. Further, the user equipment 100 checks whether the calculated similarity (or similarity of feature information between two objects) is equal to or higher than a predetermined reference value.

For example, when a first object recognized in the first image information is a single object, the user equipment 100 calculates a first similarity (for example, 95%) between feature information of the recognized first object and feature information of a predetermined reference object. Further, the user equipment 100 checks whether the calculated first similarity (for example, 95%) is equal to or higher than the predetermined reference value (for example, 90%).

As another example, when a first object recognized in the first image information is a single object, the user equipment 100 calculates a second similarity (for example, 85%) between feature information of the recognized first object and feature information of the predetermined reference object. Further, the user equipment 100 checks whether the calculated second similarity (for example, 85%) is equal to or higher than the predetermined reference value (for example, 90%) (S540).

When the feature information of the recognized object is similar to the feature information of the predetermined reference object (or the calculated similarity of feature information between two objects is equal to or higher than the predetermined reference value) as a checking result, the user equipment 100 confirms to be a normal state and repeatedly performs the process of obtaining image information through the front camera 161, the process of recognizing an object in the image information, and a process of determining whether a user for the recognized object is real until information in accordance with user input (or user selection) in a previous step is completely received.

For example, when the calculated first similarity (for example, 95%) of feature information between two objects is equal to or higher than a predetermined reference value (for example, 90%), the user equipment 100 confirms to be a normal state and returns to an initial step (for example, step S510) of obtaining image information through the front camera 161 until the information in accordance with the user input (or user selection) in a previous step is completely received (S550).

Further, when a plurality of object is included in the image information as a previous determination result or the feature information of the recognized object is not similar to the feature information of the predetermined reference object (or the calculated similarity of feature information between two objects is lower than the predetermined reference value) as the previous determination result, the user equipment 100 suppresses information leakage on the predetermined screen in accordance with user input (or user selection) through a predetermined function. Here, the predetermined function includes a function of notifying the user that a face of a third party is detected, a function of displaying a color of an input keyboard displayed on the user equipment 100 to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment 100 to a direction to block eyes of the third party.

Further, the user equipment 100 repeatedly performs a process of obtaining image information through the front camera 161, a process of recognizing an object in the image information, and a process of determining whether a user for the recognized object is real until information in accordance with user input (or user selection) in a previous step is completely received.

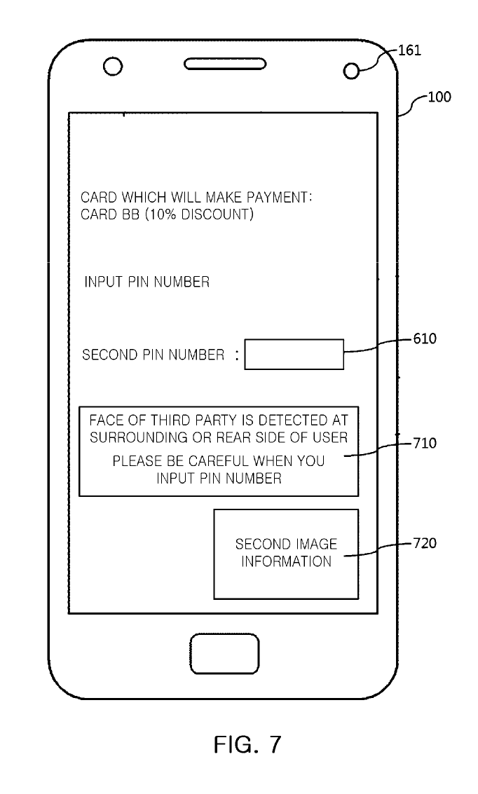

For example, as a determination result (or a determination result in step S530), when the plurality of objects (for example, including a first object and a second object) is recognized in the second image information, as illustrated in FIG. 7, the user equipment 100 displays information 710 indicating that a face of a third party is detected and second image information 720 obtained through the front camera 161.

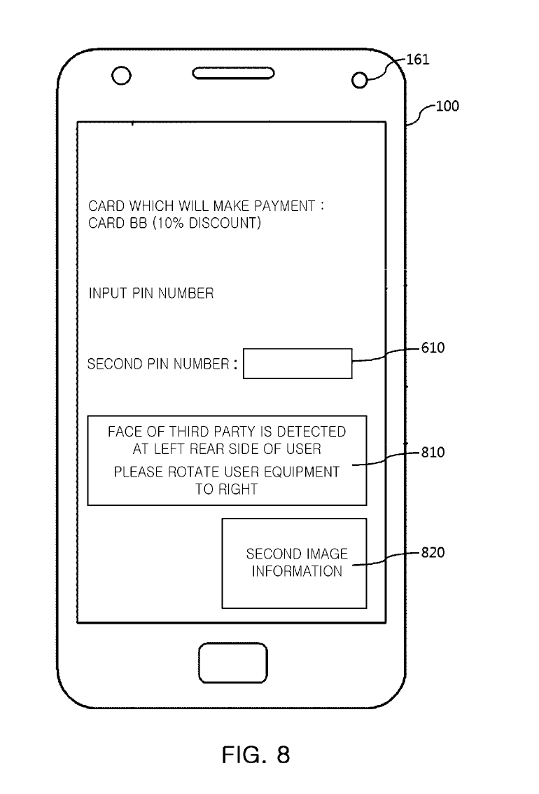

As another example, as a checking result (or a checking result in step S540), when the calculated second similarity (for example, 85%) of feature information between two objects is lower than the predetermined reference value (for example, 90%), as illustrated in FIG. 8, the user equipment 100 displays information 810 of guiding the direction of the user equipment to be changed in a direction to block the eyes of the third party, and second image information 820 obtained through the front camera 161 (S560).

Next, when information in accordance with the user input (or user selection) is received, the user equipment 100 ends a process of obtaining image information through the front camera 161 (or an image information obtaining process, an object recognizing process, and a process of determining whether a user for the recognized object is real) (or stops (or turns off) an operation of the front camera 161) and transmits the received information and the identification information of the user equipment 100 to the service providing device 300.

For example, when a first PIN number (for example, 123456) corresponding to a payment card AA in accordance with the user input, the user equipment 100 stops the operation of the front camera 161 and transmits information on payment card AA, the first PIN number corresponding to the payment card AA, and identification information of the user equipment 100 to the service providing device 300 (S570).

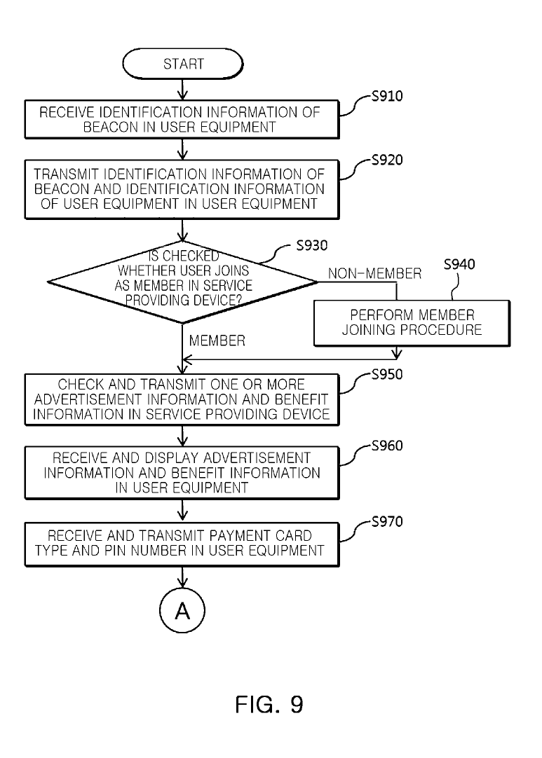

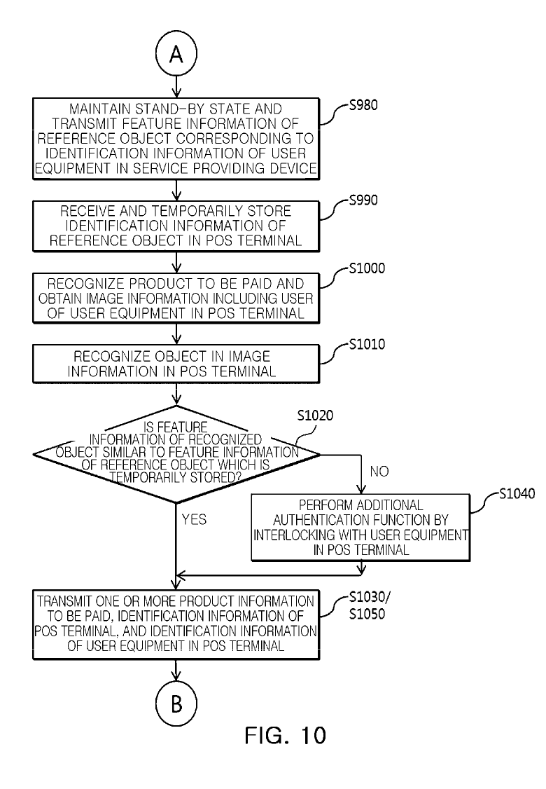

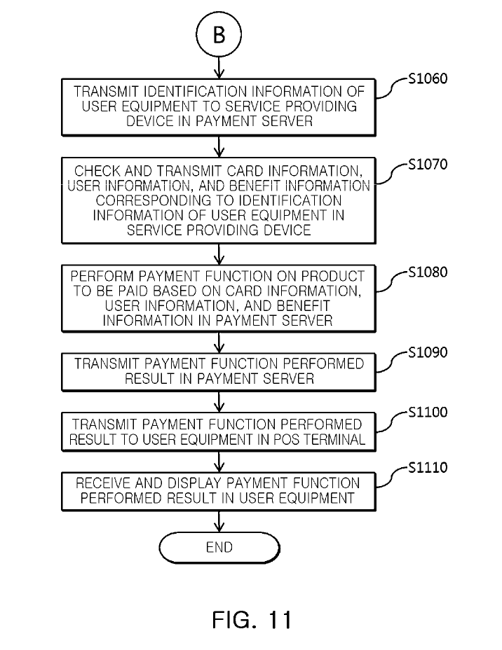

FIGS. 9 and 11 are flow charts illustrating a control method of a payment system according to a second exemplary embodiment of the present invention.

Further, when a user who carries the user equipment 100 enters a store, the user equipment 100 receives the identification information (or unique identification information of a store provided with the beacon 200) of the beacon 200 transmitted from the beacon 200.

For example, when a user who carries the user equipment 100 enters a store A, the user equipment 100 receives identification information of the beacon broadcasted (or transmitted) from the beacon 200 equipped in the store A (S910).

Further, the user equipment 100 transmits the received unique identification information of the beacon 200 (or the unique identification information of a store equipped with the beacon 200) and the identification information of the user equipment 100 to the service providing device 300. Here, the identification information of the user equipment 100 includes a mobile directory number (MDN), a mobile IP, a mobile MAC, a subscriber identify module (Sim) card unique information, and a serial number.

Further, in order to notify (or inform) the service providing device 300 that the user equipment 100 enters the store, the user equipment 100 transmits the received unique identification information of the beacon 200 and the identification information of the user equipment 100 to the service providing device 300 (S920).

Next, the service providing device 300 receives the unique identification information of the beacon 200 and the identification information of the user equipment 100 transmitted from the user equipment 100.

Further, the service providing device 300 determines (or checks) whether the user corresponding to the user equipment 100 is a member who is registered (joined) in advance in the service providing device 300 based on the received identification information of the user equipment 100.

For example the service providing device 300 determines whether the user joins as a member based on the identification information of the user equipment 100 (S930).

When the user corresponding to the user equipment 100 is not a member who is registered in advance in the service providing device 300 as a determination result (or a checking result), the service providing device 300 transmits guide information related with the member joining procedure to the user equipment 100.

Further, the service providing device 300 interlocks with the user equipment 100 to perform a member joining procedure for the user equipment 100 (or the user of the user equipment 100).

Further, a member joining procedure on the user equipment 100 is normally completed and the following subsequent processes may be normally performed.

When the user equipment 100 is not a member who is registered in advance in the service providing device 300, the service providing device 300 interlocks with the user equipment 100 to perform a member joining procedure on the user equipment 100 based on guide information related with the member joining (S940).

Further, when the user corresponding to the user equipment 100 is a member who is registered in advance in the service providing device 300 as a determination result (or a checking result), the service providing device 300 checks one or more advertisement information and one or more benefit information which may be provided to the user equipment 100 in the store provided with the beacon 200, among a plurality of advertisement information and a plurality of benefit information which are stored in advance based on the unique identification information of the beacon 200 which is previously received and the identification information of the user equipment 100.

Further, the service providing device 300 creates a recommended card list including one or more recommended cards to which the benefit information may be applied (or reflected) among a plurality of cards (or a plurality of payment cards) issued to the user equipment 100, based on one or more checked benefit information. Here, the benefit information includes coupon information, membership benefit information, and discount benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

That is, when the user corresponding to the user equipment 100 is a member who is registered in advance in the service providing device 300, the service providing device 300 checks store information corresponding to the unique identification information of the beacon 200 among store information for every unique identification information of the plurality of beacons which is stored in advance. Further, the service providing device 300 checks one or more advertisement information and benefit information which may be provided to the user equipment 100 in the store based on the checked store information and the received identification information of the user equipment 100. Further, the service providing device 300 creates the recommended card list including at least one card to which the benefit information is applied, among a plurality of cards (or one or more cards) which is previously issued to the user equipment 100. Further, the service providing device 300 transmits one or more checked advertisement information, one or more checked benefit information, and the created recommended card list to the user equipment 100.

For example, when the user equipment 100 is a member who is registered in advance in the service providing device 300, the service providing device 300 checks clothing store information corresponding to the unique identification information of the beacon 200 among store information for every unique identification information of the plurality of beacons which is stored in advance. Further, the service providing device 300 checks first to third advertisement information and first and second benefit information (for example, including discount coupon information and membership benefit information) which may be provided to the user equipment 100 in the clothing store based on the checked clothing store information and the identification information of the user equipment 100. Further, the service providing device 300 creates a recommended card list including a card AA, a card BB, a card CC, and a card DD to which the first and second benefit information may be applied, among a plurality of cards which is issued to the user equipment 100. Further, the service providing device 300 transmits the checked first to third advertisement information and first and second benefit information (for example, including discount coupon information and membership benefit information) and the recommended card list including a card AA, a card BB, a card CC, and a card DD to the user equipment 100 (S950).

Thereafter, the user equipment 100 receives one or more advertisement information, one or more benefit information, and a recommended card list in response to the unique identification information of the beacon 200 which is previously transmitted and the identification information of the user equipment 100.

Further, the user equipment 100 displays the received one or more advertisement information, one or more benefit information, and recommended card list.

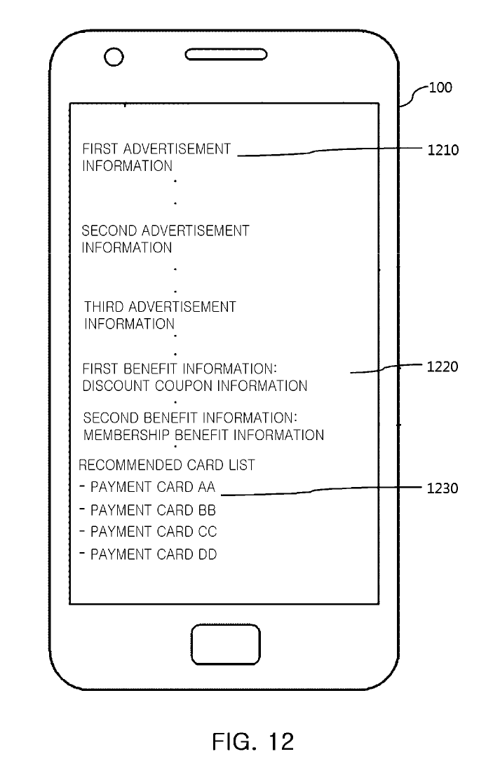

For example, as illustrated in FIG. 12, the user equipment 100 displays the first to third advertisement information 1210 transmitted from the service providing device 300, the first and second benefit information 1220 (for example, including discount coupon information and membership benefit information) which may be provided in the clothing store, and based on the checked clothing store information and the recommended card list (for example, including the payment card AA, the payment card BB, the payment card CC, and the payment card DD) 1230 (S960).

Thereafter, the user equipment 100 receives a payment card type (or unique identification information of the payment card) in accordance with the user input (or user selection) and a PIN number through a specific app which is installed in advance in the user equipment 100.

That is, the user equipment 100 checks the payment card type which is selected in accordance with the user input (or user selection) among a plurality of cards which is registered in advance in the user equipment 100. In this case, the user equipment 100 may check a payment card type (or unique identification information of the payment card) of a payment card selected from the recommended card list transmitted from the service providing device 300.

Further, the user equipment 100 receives a PIN number in accordance with the user input (or user selection) through the specific app which is installed in advance in the user equipment 100. Here, the PIN number may be a PIN number corresponding to the checked payment card type.

Further, the user equipment 100 transmits the checked payment card type (or unique identification information of the payment card), the PIN number, and the identification information of the user equipment 100 to the service providing device 300.

For example, the user equipment 100 checks one payment card AA selected from a plurality of payment cares which is registered (or issued) to an electronic wallet app which is installed in advance in the user equipment 100. Further, the user equipment 100 receives the PIN number in accordance with the user input through the electronic wallet app. Further, the user equipment 100 transmits the checked payment card AA (or a type of the payment card AA), the received PIN number corresponding to the payment card AA, and the identification information of the user equipment 100 to the service providing device 300.

As another example, the user equipment 100 checks a payment card BB selected from the recommended card list displayed on the user equipment 100. Further, the user equipment 100 receives the PIN number corresponding to the payment card BB in accordance with the user input through the electronic wallet app. Further, the user equipment 100 transmits the checked payment card BB (or a type of the payment card BB), the received PIN number, and the identification information of the user equipment 100 to the service providing device 300 (S970).

Next, the service providing device 300 receives the payment card type, the PIN number, and the identification information of the user equipment 100 transmitted from the user equipment 100.

Further, the service providing device 300 maintains a stand-by status (or check-in status) for simple payment.

Further, the service providing device 300 checks feature information of a reference object (or the user of the user equipment 100) corresponding to the identification information of the user equipment 100 among feature information of a plurality of objects for every user equipment which is stored in advance and transmits the feature information of the reference object corresponding to the checked identification information of the user equipment 100 to the POS terminal 400 related with unique identification information of the beacon 200.

For example, the service providing device 300 checks feature information of the reference object corresponding to the identification information of the user equipment 100 among feature information of objects for a plurality of user equipment stored in advance and transmits the checked feature information of the reference object to the POS terminal 400 configured in the store A equipped with the beacon 200 corresponding to the unique identification information of the beacon 200.

In the exemplary embodiment of the present invention, it is described that when the stand-by state for simple payment is maintained in the service providing device 300, feature information of the reference object corresponding to the identification information of the user equipment 100 is transmitted to the POS terminal. However, the present invention is not limited thereto and when previously checked one or more advertisement information, one or more benefit information and generated recommended card list are transmitted to the user equipment 100, feature information of the reference object corresponding to the identification information of the user equipment 100 is checked and the checked feature information of the reference object corresponding to the identification information of the user equipment 100 may be transmitted to the POS terminal 400 (S980).

Thereafter, the POS terminal 400 receives feature information of the reference object related with the user of the user equipment 100 who enters (or visits) a store equipped with the POS terminal, transmitted from the service providing device 300.

Further, the POS terminal 400 temporarily stores the received feature information (or feature information of the reference object corresponding to the identification information of the user equipment 100) of the reference object.

For example, the POS terminal 400 equipped in the store A receives feature information of the reference object related with the user of the user equipment 100 who enters the store A transmitted from the service providing device 300 and maintains a stand-by state (or check-in state) in a state when the received feature information of the reference object related with the user of the user equipment 100 is temporarily stored (S990).

Thereafter, the POS terminal 400 scans (or recognizes a barcode attached on a product to be paid) one or more products (or payment products) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

That is, the POS terminal 400 scans the product to be paid among one or more products to be paid selected by the user of the user equipment 100 through the recognizing unit 450 and obtains (or photographs) image information including the user of the user equipment 100 through the photographing unit 460 in a background state.

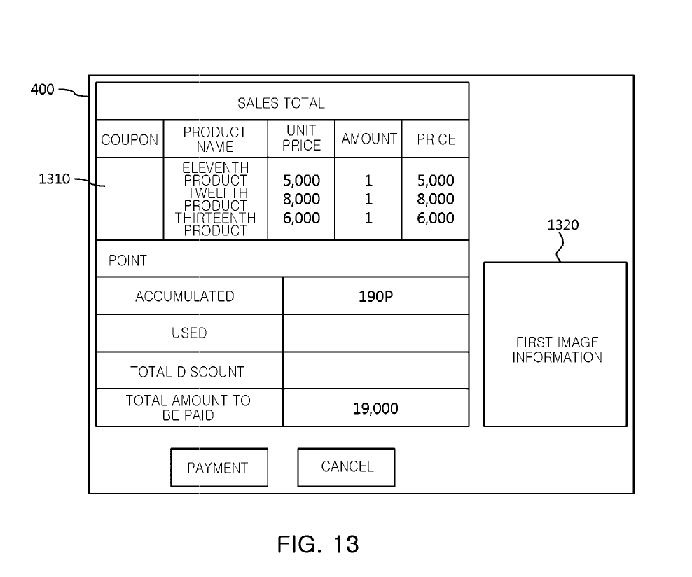

For example, the POS terminal 400 recognizes barcodes attached on eleventh to thirteenth products which are selected by the user of the user equipment 100 and as illustrated in FIG. 13, displays product information 1310 on the recognized eleventh to thirteenth products, and displays first image information 1320 including a user of the user equipment 100 obtained by the photographing unit 460 (S1000).

Next, the POS terminal 400 performs an object recognizing function on the obtained image information.

That is, the POS terminal 400 extracts (or calculates) feature information in the obtained image information.

Further, the POS terminal 400 recognizes (or discerns) one or more objects included in the image information based on the extracted feature information.

For example, the POS terminal 400 extracts feature information in the obtained first image information and recognizes a first object (or an object corresponding to a user who carries the user equipment 100) included in the first image information based on the extracted feature information (S1010).

Next, the POS terminal 400 checks (or determines) whether feature information of the recognized object is similar to the feature information of the reference object corresponding to the identification information of the user equipment 100 provided from the service providing device 300. Here, the feature information of the predetermined reference object may be feature information related with the user of the user equipment 100.

That is, the POS terminal 400 calculates a similarity between the feature information of the recognized object and the feature information of the reference object corresponding to the identification information of the user equipment 100. Further, the POS terminal 400 checks (or determines) whether the calculated similarity (or similarity of feature information between two objects) is equal to or higher than a predetermined reference value.

For example, the POS terminal 400 calculates a first similarity (for example, 95%) between feature information of the first object recognized in the first image information and feature information of a predetermined reference object. Further, the POS terminal 400 checks whether the calculated first similarity (for example, 96%) is equal to or higher than the predetermined reference value (for example, 90%).

As another example, the POS terminal 400 calculates a second similarity (for example, 87%) between feature information of the first object recognized in the first image information and feature information of a predetermined reference object. Further, the POS terminal 400 checks whether the calculated second similarity (for example, 87%) is equal to or higher than the predetermined reference value (for example, 90%) (S1020).

When the feature information of the recognized object is similar to the feature information of the reference object corresponding to the identification information of the user equipment 100 (or the calculated similarity of the feature information between two objects is equal to or higher than a predetermined reference value) as a checking result, the POS terminal 400 determines that a payer who makes a payment matches the previously registered user and transmits one or more product information to be paid (or recognized product information to be paid), identification information of the POS terminal 400, and the identification information of the user equipment 100 to the payment server 500, in order to perform a payment function in accordance with a predetermined payment method which is selected by a specific app which is installed in advance in the user equipment 100. In this case, the payment method includes cash payment, credit card payment, or electronic payment and the predetermined payment method may be electronic payment.

For example, when the calculated first similarity (for example, 96%) of the feature information between two objects is equal to or higher than a predetermined reference value (for example, 90%), the POS terminal 400 receives payment request information through a predetermined electronic payment transmitted from the user equipment 100 through BLE communication and transmits product information on recognized eleventh to thirteenth products, the identification information of the POS terminal 400, and the identification information of the user equipment 100 to the payment server 500 (S1030).

Further, when the feature information of the recognized object is not similar to the feature information of the reference object corresponding to the identification information of the user equipment 100 (or the calculated similarity of the feature information between two objects is lower than a predetermined reference value) as the checking result, the POS terminal 400 determines that the payer who makes a payment does not match the previously registered user and requests additional authentication to the user equipment 100 in order to suppress illegal use of the payment card.

Further, the POS terminal 400 interlocks with the user equipment 100 to perform the additional authentication function (for example, including phone authentication or payment card checking) based on the previously requested additional authentication.

For example, when the calculated second similarity (for example, 87%) of the feature information between two objects is lower than the predetermined reference value (for example, 90%), the POS terminal 400 interlocks with the user equipment 100 to perform the additional authentication function.

Further, when the feature information of the recognized object is not similar to the feature information of the reference object corresponding to the identification information of the user equipment 100 (or the calculated similarity of the feature information between two objects is lower than a predetermined reference value) as the checking result, the POS terminal 400 determines that the payment card is illegally used to generate authentication failure information (or payment failure information) and transmit the generated authentication failure information to the user equipment 100.

The user equipment 100 receives the authentication failure information transmitted from the POS terminal 400 and displays the received authentication failure information (S1040).

After normally performing additional authentication procedure between the POS terminal 400 and the user equipment 100, the POS terminal 400 transmits one or more product information to be paid (or recognized product information to be paid), the identification information of the POS terminal 400, and the identification information of the user equipment 100 to the payment server 500, in order to perform a payment function in accordance with a predetermined payment method which is selected by a specific app which is installed in advance in the user equipment 100. In this case, the payment method includes cash payment, credit card payment, or electronic payment and the predetermined payment method may be electronic payment.

For example, after normally performing an additional authentication procedure between the POS terminal 400 and the user equipment 100, the POS terminal 400 receives payment request information through a predetermined electronic payment transmitted from the user equipment 100 through BLE communication and transmits product information on recognized eleventh to thirteenth products, the identification information of the POS terminal 400, and the identification information of the user equipment 100 to the payment server 500 (S1050).

The payment server 500 receives information on one or more products to be paid (or recognized product information to be paid) transmitted from the POS terminal 400, the identification information of the POS terminal 400, and the identification information of the user equipment 100.

Further, the payment server 500 transmits the identification information of the user equipment 100 in order to perform an authentication procedure related with the user equipment 100.

For example, the payment server 500 receives product information on recognized eleventh to thirteenth products transmitted from the POS terminal 400, the identification information of the POS terminal 400, and the identification information of the user equipment 100 and transmits the received identification information of the user equipment 100 to the service providing device 300 (S1060).

Next, the service providing device 300 receives identification information of the user equipment 100 transmitted from the payment server 500.

Further, the service providing device 300 checks information (or payment card/payment card type) on the payment card stored (or temporarily stored) related with the user equipment 100 and the PIN number (or a PIN number corresponding to the information on the payment card) based on the received identification information of the user equipment 100.

Further, the service providing device 300 transmits the card information, the user information, and the benefit information corresponding to the identification information of the user equipment 100 and/or the information (or payment card/payment card type) on the payment card to the payment server 500. Here, the card information includes a card number, an expiration date, a CVC number, and a user name of a card which is registered in advance in the user equipment 100. The user information includes a user name, birth date, an address, and an image.

That is, the service providing device 300 checks the card information, the user information, and the benefit information which are stored in advance in the service providing device 300 related with the user (or the user equipment 100) corresponding to the identification information of the user equipment 100 and/or the information (or payment card/payment card type) on the payment card and transmits the checked card information, the user information, and the benefit information to the payment server 500.

For example, the service providing device 300 transmits identification information of the user equipment 100 and first card information, first user information, and first benefit information corresponding to the information on the payment card AA to the payment server 500.

Further, the service providing device 300 checks (or performs an authentication procedure) whether the payment card issued to the user equipment 100 is valid based on information (or payment card/payment card type) on the payment card stored (or temporarily stored) related with the user equipment 100 and the PIN number (or a PIN number corresponding to the information on the payment card). When the payment card is valid as a checking result (the authentication procedure performed result), the service providing device 300 transmits the card information corresponding to the payment card, the user information, and the benefit information (S1070).

Next, the payment server 500 receives card information, user information, and benefit information which are transmitted from the service providing device 400 in response to the identification information of the user equipment 300 which is previously transmitted.

The payment server 500 performs a payment function on the payment amount corresponding to one or more product information to be paid based on the received card information, user information, and benefit information. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

For example, the payment server receives first card information, first user information, and first benefit information which are transmitted from the service providing device 300 in response to the identification information of the user equipment 100 which is previously transmitted) and performs a payment function on a payment amount to which a benefit price corresponding to the first benefit information is applied to the eleventh to thirteenth products to be paid (S1080).

Next, the payment server 500 transmits the payment function performed result (or payment information) to the POS terminal 400 and the service providing device 300. Here, the payment function performed result (or the payment information) includes a product name, a unique product code, a unit price, an amount, a discounted price, whether to apply a coupon, a price, a total price, payment date and time information, and a payment card type.

For example, the payment server transmits the payment function result performed result on the eleventh to thirteenth products to the POS terminal 400 and the service providing device 300 (S1090).

Next, the POS terminal receives the payment function performed result transmitted from the payment server 500.

The POS terminal 400 transmits the received payment function performed result to the user equipment 100.

For example, the POS terminal transmits the received payment function performed result on eleventh to thirteenth products to the user equipment 100.

Further, the POS terminal 400 may output the received payment function performed result through a printed matter such as a receipt (S1100).

Next, after normally performing the payment function on previously selected one or more products, the user equipment 100 receives a payment function performed result transmitted from the POS terminal 400.

Further, the user equipment 100 displays the received payment function performed result.

For example, the user equipment 100 receives the payment function performed result on the eleventh to thirteenth products. Further, the user equipment 100 displays the payment function performed result through the electronic wallet app (S1110).

The user equipment, the service providing device, the POS terminal, and the payment system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user equipment, the beacon, the service providing device, the POS terminal, and the payment server according to the exemplary embodiment of the present invention to implement the user equipment, the service providing device, the POS terminal, and the payment system including the same.

The non-transitory computer readable storage medium includes a magnetic storage medium, an optical storage medium, and a carrier wave medium. The computer program implementing the user equipment, the service providing device, the POS terminal, and the payment system including the same according to the embodiment of the present invention may be stored and installed in embedded memories of the user equipment, the beacon, the service providing device, the POS terminal, and the payment server. Alternatively, external memories such as a smart card storing and installing the computer program implementing the user equipment, the service providing device, the POS terminal, and the payment system including the same according to the embodiment of the present invention may be installed on the user equipment, the beacon, the service providing device, the POS terminal, and the payment server through an interface.

According to the present invention, as described above, when privacy information, important information, or a password is input on a payment screen, a rear side of the user which cannot be watched by the user is monitored through a front camera equipped in user equipment to suppress a peeping situation by a third party and when a face of the third party is detected, it is notified to the user so that when a service such as payment or baking is used using mobile user equipment, a load of the user equipment may be reduced while increasing security.

Further, according to the present invention, as described above, the user is checked through a front camera on a payment screen and the user is basically discerned and the third party is checked using feature points of the face of the user, so that basic user authentication and suppressing of peeping by a third party may be performed without performing separate manipulation of the user.

Further, according to the present invention, as described above, a face of the user is analyzed using a camera configured in a POS terminal to check and discern whether the user joins as a member and image information obtained through the camera when the user makes a payment is stored as a history, so that illegal use of the payment card is suppressed and when the payment card is illegally used, the payment card may be tracked.

Further, according to the present invention, as described above, when a check-in procedure is performed through a beacon at the time of performing simple payment, information on a user of user equipment is detected to provide the information to the POS terminal and the user of the user equipment is discerned by the POS terminal. Therefore, even in a bad communication environment, the user may be effectively discerned and the security is improved and a terminal manipulating load of the user is reduced, thereby improving convenience.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments and the following claims as well as all modified equally or equivalently to the claims are intended to fall within the scope and spirit of the invention.

According to the present invention, when privacy information, important information, or a password is input on a payment screen, a rear side of the user which cannot be watched by the user is monitored through a front camera equipped in user equipment to suppress a peeping situation by a third party and when a face of the third party is detected, it is notified to the user so that when a service such as payment or baking is used using mobile user equipment, a load of the user equipment may be reduced while increasing security. As a result, the present invention may be broadly used in various fields such as a simple payment field, an advertisement field, a service providing device field, a user equipment field, a POS terminal field, a payment server field, and a security field.

What is claimed is:

1. User equipment, comprising:
a user equipment display unit which displays a predetermined screen to receive information in accordance with user input;
a front camera which obtains image information when the predetermined screen is displayed on the user equipment display unit; and
a user equipment control unit which performs an object recognizing function on the obtained image information to recognize one or more objects included in the image information and checks whether information is leaked from the predetermined screen during an information receiving process, based on a feature of one or more recognized objects.

2. The user equipment according to claim 1, wherein the predetermined screen includes any one of a PIN number receiving screen for receiving a PIN number corresponding to a selected payment card after selecting a payment card, a payment card number receiving screen for receiving a payment card information, a security card number receiving screen for receiving a security card number, and a personal information receiving screen for receiving personal information.

3. The user equipment according to claim 1, wherein the front camera obtains surrounding and rear image information of the user in a state when the user of the user equipment watches the front camera.

4. The user equipment according to claim 1, wherein when the recognized object is a single object, the user equipment control unit calculates a similarity between feature information of the recognized object and feature information of a predetermined reference object and checks whether the calculated similarity is equal to or higher than the predetermined reference value.

5. The user equipment according to claim 4, wherein when the calculated similarity is lower than the predetermined reference value, the user equipment control unit suppresses information leakage in accordance with the user input in a predetermined screen displayed on the user equipment display unit through a predetermined function.

6. The user equipment according to claim 1, wherein when a plurality of objects is recognized, the user equipment control unit suppresses information leakage in accordance with the user input in a predetermined screen displayed on the user equipment display unit through a predetermined function.

7. The user equipment according to claim 5, wherein the predetermined function includes at least one of a function of notifying the user that a face of a third party is detected, a function of displaying a color of an input keyboard displayed on the user equipment display unit to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment to a direction to block eyes of the third party.

8. The user equipment according to claim 6, wherein the predetermined function includes at least one of a function of notifying the user that a face of a third party is detected, a function of displaying a color of an input keyboard displayed on the user equipment display unit to be blurred, a function of converting a sentence input keyboard screen into a letter input keyboard screen, a function of displaying an input keyboard screen in an opposite direction to a direction where the third party in the image information is located, and a function of displaying a guide of changing a direction of the user equipment to a direction to block eyes of the third party.

9. A POS terminal, comprising:
a communication unit which receives feature information of an object corresponding to identification information of user equipment which visits a store equipped with the POS terminal, transmitted from a service providing device;
a storing unit which temporarily store the received feature information of the object corresponding to the identification information of the user equipment;
a recognizing unit which scans one or more products to be paid which are selected by a user of the user equipment;
a display unit which displays product information on the scanned one or more products to be paid;
a photographing unit which obtains image information including the user of the user equipment in a background state, while scanning the one or more products to be paid by means of the recognizing unit; and
a control unit which recognizes one or more objects included in the image information by performing an object recognizing function on the obtained image information and checks whether a payment card is illegally used based on the feature information of the recognized one or more objects and the feature information of the object corresponding to the identification information of the user equipment which is temporarily stored in the storing unit.

10. The POS terminal according to claim 9, wherein the control unit extracts feature information in the obtained image information and recognizes one or more objects included in the image information based on the extracted feature information.

11. The POS terminal according to claim 9, wherein the control unit calculates a similarity between the feature information of the recognized one or more objects and the feature information of the object corresponding to the identification information of the user equipment which is temporarily stored in the storing unit and checks whether the calculated similarity is equal to or higher than a predetermined reference value.

12. The POS terminal according to claim 11, wherein when the calculated similarity is equal to or higher than the predetermined reference value, the control unit determines that a payer who makes a payment matches a user which is registered in advance to control the communication unit to transmit one or more product information to be paid, identification information of the POS terminal, and the identification information of the user equipment to a payment server to perform a payment function by a predetermined payment method which is selected through a specific app which is installed in advance in the user equipment.

13. The POS terminal according to claim 11, wherein when the calculated similarity is lower than the predetermined reference value, the control unit interlocks with the user equipment to perform an additional authentication procedure.

14. A control method of user equipment, the method comprising:
displaying a predetermined screen to receive information in accordance with user input by means of a user equipment display unit;
obtaining surrounding and rear image information of the user in a state when a user of the user equipment watches a front camera when the predetermined screen is displayed on the user equipment display unit, by means of the front camera;
recognizing one or more objects included in the image information by performing an object recognizing function on the obtained image information by means of a user equipment control unit;
determining whether one object is included in the recognized image information, by means of the user equipment control unit;
checking whether feature information of the recognized object is similar to feature information of a predetermined reference object when one object is included in the recognized image information, by means of the user equipment control unit; and
suppressing information leakage in accordance with user input on a predetermined screen displayed on the user equipment display unit through a predetermined function by means of the user equipment control unit when a plurality of objects is included in the recognized image information as a determination result and/or feature information of the recognized object is not similar to the feature information of the predetermined reference object.

15. The control method according to claim 14, further comprising:
returning to the obtaining of surrounding and rear image information of the user when the feature information of the recognized object is similar to the feature information of the predetermined reference object as the determination result;
stopping an operation of the front camera, by means of the user equipment control unit when information in accordance with the user input is received; and
transmitting the received information, information on a payment card corresponding to the information, and identification information of the user equipment to a service providing device, by means of a user equipment communication unit.

16. A non-transitory computer-readable storage medium storing a computer program recorded thereon configured to perform the method according to claim 14.

17. A non-transitory computer-readable storage medium storing a computer program recorded thereon configured to perform the method according to claim 15.
